(19) United States
(12) Patent Application Publication
(10) Pub. No.: US 2025/0276714 A1
(43) Pub. Date: Sep. 4, 2025

(54) TRAJECTORY DETERMINATION BASED ON PROBABILISTIC GRAPHS

(71) Applicant: Zoox, Inc., Foster City, CA (US)

(72) Inventors: Parthasarathi Ainampudi, Sunnyvale, CA (US); Timothy Caldwell, Boulder, CO (US); Rasmus Fonseca, Boulder Creek, CA (US); Joseph Lorenzetti, Foster City, CA (US); Mathew Michail MacDougall, San Mateo, CA (US); Jack Riley, San Francisco, CA (US); Olivier Amaury Toupet, Escondido, CA (US); Krishna Viralbhai Trivedi, Foster City, CA (US)

(21) Appl. No.: 18/591,301

(22) Filed: Feb. 29, 2024

(51) Int. Cl. B60W 60/00

(52) U.S. Cl. CPC B60W 60/001; B60W 2554/4041; B60W 2720/10

(57) ABSTRACT

Techniques for determining a driving trajectory for an autonomous vehicle to follow are described herein. A vehicle may receive a destination associated with a region of an environment to which the vehicle is to navigate. Based on the destination, the vehicle can generate a local probabilistic graph that includes states, edges connecting the states, actions for the vehicle to perform along the graph, and/or probabilities associated with the actions. The vehicle may determine cost-to-go values for each state within the local probabilistic graph. While navigating to the destination, the vehicle can generate candidate trajectories. When determining the cost of following a candidate trajectory, the vehicle can determine the cost by projecting an ending state of the candidate trajectory onto the local probabilistic graph to determine an optimal action which considers a larger understanding of the goal of the vehicle. The vehicle can be controlled based on the candidate trajectory.

### BACKGROUND

Vehicles, such as autonomous vehicles, may navigate along designated routes. In some examples, autonomous vehicles may encounter various types of static and/or dynamic objects within an environment. In some circumstances, the autonomous vehicle may use sensors to detect and/or classify these objects. Upon detecting such objects, the autonomous vehicle may determine a trajectory to follow through the environment based on the objects, amongst many other environmental factors. Such a trajectory may be determined based on one or more associated costs. However, in certain circumstances, techniques for determining costs can result in inaccurate cost measurements and/or the selection of suboptimal trajectories for the vehicle to follow through the environment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flow diagram illustrating an example technique for determining a trajectory to follow based on a probabilistic graph, in accordance with one or more examples of the disclosure.

FIG. 2 illustrates an example computing system including a planning component configured to generate and/or update local probabilistic graph(s) and use such graph(s) to determine a trajectory for a vehicle to follow, in accordance with one or more examples of the disclosure.

FIG. 3 depicts an example environment and an example probabilistic graph that includes a local search horizon, modified probabilities based on environmental factors, and/or an alternative action based on an object blocking at least a portion of a driving lane, in accordance with one or more examples of the disclosure.

FIG. 4 illustrates determining an optimal policy (or action) based on a local graph, in accordance with one or more examples of the disclosure.

FIG. 5 is a pictorial flow diagram illustrating an example technique for determining a cost associated with a candidate trajectory based on accessing a local graph, in accordance with one or more examples of the disclosure.

FIG. 6 depicts a block diagram of an example system for implementing various techniques described herein.

FIG. 7 is a flow diagram illustrating an example process for receiving a destination, generating a local graph, determining cost(s) associated with the local graph, determining a cost associated with a trajectory based on the local graph, and controlling a vehicle based on the trajectory, in accordance with one or more examples of the disclosure.

### DETAILED DESCRIPTION

When determining or otherwise selecting a candidate trajectory to follow based on costs associated with such candidate trajectories, it would be beneficial for the costs to reflect not only the costs associated with navigating within the trajectory time horizon but beyond the time horizon of the candidate trajectories. Accordingly, the systems described herein determine cost-to-go graphs that enable a vehicle to determine cost(s) for trajectories that reflect the cost of navigating to a destination beyond the time horizon of the trajectory.

Techniques for determining or otherwise selecting a driving trajectory for an autonomous vehicle to follow are described herein. As discussed below, probabilistic graphs may be generated and/or updated to enable a vehicle to determine and/or receive cost(s) associated with following a candidate trajectory within the environment. In some examples, a vehicle (such as an autonomous vehicle) may receive a destination associated with a region of an environment to which the vehicle is to navigate. Based on the destination, the vehicle can receive or otherwise generate a local probabilistic graph that includes a plurality of states (or nodes), a plurality of edges between or otherwise connecting the plurality of states, a plurality of actions (e.g., stay in current driving lane, change driving lanes, etc.) for the vehicle to perform along the graph, and/or a plurality of probabilities (e.g., probability of transitioning to a state given an action) associated with the plurality of actions. In some examples, the vehicle may determine terminal cost-to-go values (e.g., cost values representing an estimation of the cost to travel from a state to the destination or the boundary of the local graph if the destination is not within the local graph) for each state within the local probabilistic graph.

While navigating the environment to the destination, the vehicle can generate one or more candidate trajectories. When determining the cost of following a candidate trajectory, the vehicle can access, receive, and/or determine/update the cost based on projecting an ending state of the candidate trajectory onto the local graph to determine an optimal action which takes into account a larger understanding of the goal of the vehicle. In such instances, the vehicle can be controlled based on the candidate trajectory. As described in more detail below, the techniques may improve vehicle safety and driving efficiency by determining costs representative of the cost-to-go from a position (or node) to the destination location, thereby enabling the planning component to evaluate higher quality and/or more accurate cost values when determining which of the plurality of candidate trajectories the vehicle should follow. Such techniques may result in the vehicle performing safer and more efficient driving maneuvers.

When determining costs associated with following a candidate trajectory, conventional systems and/or techniques may be inefficient and/or lead to inaccurate or suboptimal results. For example, while traversing an environment, a vehicle can generate and/or follow various different trajectories. The vehicle can generate multiple candidate trajectories and determine which of the many candidate trajectories to follow based on evaluating the costs associated with such trajectories. To identify the most cost efficient candidate trajectory, the vehicle can determine one or more sub-costs corresponding to the efficacy and/or safety of the trajectory (e.g., costs penalizing getting too close to other objects, exceeding speed limits, not progressing toward a destination, etc.). In some examples, the vehicle may determine such sub-costs based on the data within a specified time horizon. That is, in some instances a candidate trajectory may be limited to, or extend, a predetermined period of time into the future (e.g., eight seconds, 10 seconds, etc.). However, determining costs based solely on the data within the trajectory time horizon can result in sub-costs that may fail to represent the cost of navigating beyond the time horizon. Specifically, conventional techniques may select candidate trajectories that are cost effective within the limited trajectory time horizon, but may ultimately have a negative impact on the overall cost for the vehicle beyond the limited time horizon.

For example, a vehicle may be navigating behind a second vehicle. In such instances, the vehicle may generate multiple candidate trajectories. When determining which candidate trajectory to follow, the vehicle may determine costs associated with such trajectories according to the time horizon of the trajectory. Thus, if the trajectory extends eight seconds into the future (e.g., the time horizon), the vehicle may determine costs based on objects (e.g., dynamic and/or static objects) that are located within a region of the environment that the vehicle will traverse during the limited time horizon. In this example, traveling to the ultimate destination location may require the vehicle to make a right turn at an intersection. Accordingly, if the vehicle generates costs in the absence of that requirement, the vehicle may determine that a candidate trajectory causing the vehicle to change lanes to the left to pass the slower moving vehicle may be the most cost efficient within the limited time horizon and as such, the vehicle may follow the trajectory into the left lane. However, changing lanes to the left in this example would be sub-optimal because the vehicle would then need to quickly change lanes back to the right in order to make a right turn, or may be unable to change lanes back to the right and may be forced to find an alternate route. Accordingly, despite the cost identifying efficient driving maneuvers within the limited time horizon, such maneuvers may cause the vehicle to navigate to suboptimal locations based on events and/or factors present beyond the limited time horizon. Consequently, the limitations to the conventional techniques may result in the vehicle following inefficient and/or suboptimal trajectories.

To address these and other technical problems and inefficiencies, the systems and/or techniques described herein include a planning system (which also may be referred to as a “planning component”) configured to generate a local probabilistic graph containing costs associated with traversing to the destination location enabling a vehicle to receive costs associated with candidate trajectories. Technical solutions discussed herein solve one or more technical problems by allowing the vehicle to avoid determining or otherwise selecting inefficient and/or suboptimal trajectories.

In some examples, the vehicle may receive a destination associated with a region of the environment. The vehicle may receive instruction(s) (e.g., transport passenger(s), deliver item(s), etc.) to navigate from a starting location to an ending location (or destination). Such instruction(s) may be received from a fleet management system, a remote operating system, a passenger or a passenger device, a future passenger, and/or any other source. In some examples, a destination may be a location within the environment to which the vehicle is to navigate. That is, the instructions may include a location (e.g., x-y coordinate) within the environment associated with a destination.

In some examples, a planning component may generate a local graph based on the starting location of the vehicle and the destination. A local graph may be a graph or map that represents the driving lane(s) and/or driving segment(s) (e.g., a portion of a driving lane) of the physical environment spanning or otherwise covering a smaller portion of the physical environment than that of the entire distance to the destination, while also extending beyond the distance covered by candidate trajectories. That is, the local graph may cover a larger distance from the vehicle than the distance covered by the candidate trajectories. The region of the physical environment covered by the local graph may define a local search horizon corresponding to the local graph. The local search horizon may be the region within which the planning component may determine costs of state(s) (or nodes) and/or edges based on incorporating data from the current driving scenario (e.g., detected object(s), traffic flow, etc.).

In some examples, the planning component may generate and/or update the local graph while the vehicle traverses to the destination. The planning component may generate a first instance of the local graph during the vehicle startup phase. Further, the planning component may update the local graph while the vehicle traverses the environment according to an operating tick of the planner component. An operating tick may be a frequency (e.g., 1 millisecond, 5 milliseconds, etc.) and/or duration of a processing cycle within the planning component. As such, in some examples, the planning component may update the local graph at each operating tick. However, in other examples, the local graph may be updated at any other suitable frequency (e.g., every N number of ticks, where N is an integer greater than zero, based on movement of the vehicle, velocity of the vehicle, number of additional objects proximate the vehicle, difficulty of maneuvers, proximity to the endpoint, etc.). As such, an updated local graph may span a different region of the environment than a previous version of the local graph based on the movement of the vehicle. In some examples, the planning component may generate the local graph(s) based on map data and/or by modifying the local graph from the previous tick; however, in other examples, the planning component may generate a local graph separate from previous local graphs.

In some examples, the planning component may generate the local graph based on a starting location of the vehicle and the destination. The planning component may generate a lane graph (or representation) spanning the region within the local search horizon. The lane graph may be generated based on map data, such as road network data, lane segment data (e.g., a portion of a driving lane), and/or any other type of data. In such instances, the planning component may generate or otherwise determine a lane graph based on the lane segment data (e.g., lane segment dimension, location, shape, type, etc.) and/or the combinations of lane segment(s) (or road segments) in the environment.

In some examples, the planning component may generate the local graph based on the lane graph. As indicated above, the local graph may extend from the location of the vehicle to the end of the local search horizon or to the destination (if the destination is located within the local search horizon) and contain a plurality of states, a plurality of edges, a plurality of actions, and/or a plurality of probabilities associated with transitioning between nodes according to the actions. In some instances, the planning component may generate the local graph based on modifying the lane graph (e.g., by adding features (e.g., node(s), edge(s), action(s), probabilities, transition cost(s)), etc. to the lane graph). However, in other examples, the planning component may generate a separate local graph based on or referencing the lane graph. In some examples, the planning component may generate a single local graph during the vehicle startup phase, and that local graph may be used to generate local graphs while the vehicle navigates from the starting location to the destination location.

When generating the local graph, the planning component may place state(s) (e.g., node(s)) at various locations within the local graph. A state may be a spatial state which can correspond to a point or position along the route, and each state may include a combination of geometric data such as x-position, y-position, yaw, velocity, acceleration, and/or steering angle. States may be placed at various locations such as at the location in which a new lane begins, the location of a current lane ending, the location of a lane changing types (e.g., lane changes from a driving lane to a parking lane), between two or more nodes where the distance between such nodes meets or exceeds a threshold distance, and/or any other location. Such states may be located within the driving lanes and/or along the lane markers defining the boarders of the driving lanes.

In some examples, the planning component may determine or otherwise connect two states with an edge. An edge may be a directed (e.g., representing the direction of travel) movement (e.g., kinematically feasible or non-kinematically feasible) associated with different types (e.g., models) of vehicles, though any other edge type is contemplated. In some examples, the planning component may determine, generate, and/or associate one or more edges with a single state. That is, a single state may have one or more edges entering the state (e.g., potential paths for a vehicle to navigate to the state) and/or exiting the state (e.g., potential paths for a vehicle to navigate from the state).

In some examples, the planning component may place action(s) at various locations within the local graph. An action may be a driving maneuver to perform along the graph such as a remain in current driving lane action, a change driving lanes action, a parking action, a self-cycle action (e.g., action to reduce velocity below a threshold and/or to return to a previous state), and/or any other type of action. In some examples, the action(s) may be placed at a similar or identical location as the state(s). However, in other examples, the action(s) may be placed between state(s) and at varying lateral and/or longitudinal offsets within the driving lane containing the states. That is, an action may connect two states. In some examples, the planning component may place additional actions based on one or more environmental factors. For example, a vehicle may identify an object blocking a driving lane and as such, the planning component may place additional actions to enable the vehicle to avoid the object and/or mitigate interaction. In such cases, the planning component may place a lane change action which may cause the vehicle to continue navigating the environment without becoming stuck behind the object. Additionally or alternatively, the planning component may place a self-cycling action which may cause the vehicle to perform a stopping maneuver (e.g., reduce velocity) within the driving lane at a threshold distance behind the object and/or returning to a previous state.

In some examples, the planning component may determine a probability associated with performing an action. The probability may represent a likelihood of being able to perform the action based on the vehicle following the flow of traffic. That is, the probability may be the probability of transitioning to the intended state based on the action. For example, the local graph may include a lane change action connecting a first state in a first lane with a second state in a second lane. In this example, the planning component may determine a probability that the vehicle will be able to change lanes and arrive at the second state. The planning component may determine the probability value according to the following formula:

Probability=1−exp(−at) Equation 1

In this equation, the Probability may represent the probability of transitioning to the intended state based on the action. The a may be a parameter based on a level of traffic (e.g., modify a based on the level of traffic). The t may be the transition time based on the vehicle traveling at traffic speed or at the speed limit. However, in other examples, the planning component may also determine the probability value according to the following formula:

Probability=1−exp(−ad) Equation 2

In this equation, the Probability may represent the probability of transitioning to an intended state based on an action. The a may be a parameter based on a level of traffic (e.g., modify a based on the level of traffic). The d may be the distance to travel between the two states connected by the action. In some examples, when determining the probability for the transition associated with an action, the planning component may use Equation 1 or Equation 2.

In some examples, the planning component may determine a transition cost associated with the transition associated with the action. That is, the planning component may determine a cost that represents the cost of transitioning from a first node to a second node based on an action. The planning component may determine the transition cost based on various factors such as a distance to travel between the two nodes connected by the action (e.g., larger distance may result in a higher transition cost), a time to transition between the two nodes connected by the action (e.g., higher transition times may result in higher cost values), the proximity of an object to the node to which the vehicle may transition (e.g., an object located close to (e.g., within a threshold range) the node may result in a larger transition cost), the number of lane changes required by the transition (e.g., more lane changes may result in a higher transition cost), and/or any other factor. The planning component may determine the transition costs for some or all transitions within the local graph.

Based on determining the probabilities and/or the transition costs associated with transitioning to a state based on the actions, the planning component may determine cost values associated with some or all states within the local graph. In some examples, the planning component may associate a cost-to-go (e.g., a terminal cost) with each state within the local graph. As described above, the cost-to-go may represent a cost for the vehicle to go from a state to the boundary of the local search horizon or to the destination. In some examples, the cost-to-go may be a combination of one or more sub-costs such as comfort related costs (e.g., acceleration cost, jerk cost, steering cost, path reference cost, etc.), legality related costs, policy related costs, safety related costs, progress costs, debris cost, a lane blocking cost, a lane ending cost, an exit cost, an approach cost, a space cost, a payment cost, a yaw cost, lane targeting cost (e.g., cost associated with the vehicle being located in a desired lane), and/or any other type of cost. In some examples, the planning component may determine cost-to-go values for some or all states within the local graph. As such, the planning component may initially determine cost-to-go values for the terminal states (e.g., ending states in the local graph, states that lack edges leaving the state, etc.) of the local graph. In such cases, the planning component may then proceed to determine cost-to-go values for each of the preceding states in the local graph using the cost-to-go values of the terminal state(s). In various examples, the cost-to-go may incorporate both the terminal cost as well as one or more (e.g., all) transition costs between nodes to reach a terminal node.

In some examples, the planning component may determine a cost-to-go for a non-terminal state by solving for the optimal policy. A policy may be an action taken from a particular state. That is, as described above, a state may have one or more actions the vehicle may perform such as stay in lane, change lane, etc. In this example, the optimal policy may be the action resulting in the lowest cost-to-go between the one or more actions. Accordingly, based on identifying the optimal policy for each state within the local graph, the planning component may associate the cost-to-go values of the optimal policy to the state. As an example, a first state may have a first action (leading to a second state) that is a stay in lane action with a transition probability of 1.0, a second action located at a different position within the environment with a first option (leading to a third state) to change lanes with a transition probability of 0.7 and a second option (leading to the second state) of remaining in lane with a transition probability of 0.3. When determining the optimal policy, the planning component may determine whether the first action or the second action is the optimal policy. In this example, the second state may have a cost-to-go of 10 and the third state may have a cost-to-go of 0. Accordingly, the planning component may determine the cost-to-go of the first action by solving, cost=1.0 (e.g., 1.0 is the probability associated with transitioning to the second state based on the action)*10 (e.g., 10 is the cost of the state to which the action leads) and the cost-to-go of the second action by solving, cost=(0.7*0)+(0.3*10). In this case, the cost-to-go of the first action may be 10 and the cost-to-go of the second action may be 3. As such, the optimal policy may be the second action and thus, the cost-to-go of the first state may be 3. Specifically, the planning component may determine the optimal policy using the following formula:

U^{π}(s)=Σₛ·P(s′|s,π(s))(C_{π(s)}(s,s′)+γU^{π}(s′)) Equation 3

In this example, U^{π}(s) may be the cost to go function that defines the amount of expected finite-horizon discounted costs (e.g., ensuring the solution is not infinite) received for following policy π and starting at state s. P(s′|s,π(s)) may be the probability that policy π(s) transitions the vehicle from state s to state s′. C_{π(s)}(s,s′) may be the transition cost for executing the policy π(s) from state s to state s′. U^{π}(s′) may represent the cost-to-go value of the state to which the vehicle would transition. γ may represent a weight used or otherwise applied to the cost-to-go value of the state to which the vehicle would transition. In some examples, the planning component may determine the optimal policy, π*(s), based on the following formula:

π*(s)=argmin(U^{π}(s)) Equation 4

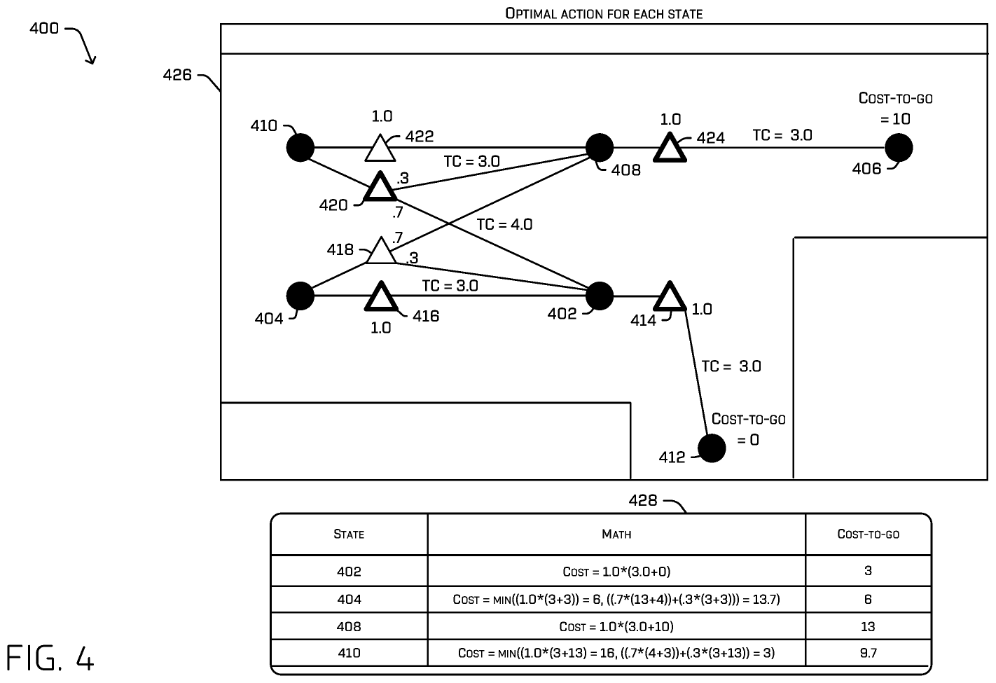

In this example, the planning component may compare the cost-to-go values for the various policies determined using Equation 3 and identify the policy with the lowest (or most favorable) cost-to-go. Based on identifying the optimal policy, the planning component may associate the associated cost-to-go of the optimal policy with the state. Additional explanation regarding determining the optimal policy is discussed in FIG. 4. The planning component may perform such operations for some or all states within the graph and as a result, the local graph may include cost-to-go values associated with each of the states therein. As described below, the planning component may access the local graph to associate a cost-to-go value of a state with a candidate trajectory.

In some examples and based on receiving the destination, the vehicle may proceed with navigating to the destination location. The planning component may generate, select, and/or follow multiple candidate trajectories through the environment to the destination. In some instances, the candidate trajectories may include instructions that instruct the vehicle how to navigate a portion of the environment. That is, the candidate trajectories may extend, from the current location of the vehicle, a predetermined distance and/or period of time. For instance, the candidate trajectories may extend eight seconds into the future, or may extend 100 meters from the location of the vehicle. However, this is not intended to be limiting; in other examples, the candidate trajectories may be based on a different period of time and/or distance. As noted above, the candidate trajectories can include instructions that cause the vehicle to perform various types of actions, such as remain in the same lane, lane change left, lane change right, pass an object proximate the vehicle, modify vehicle kinematics (e.g., velocity, acceleration, etc.), and/or any other type of action.

In some examples, a candidate trajectory may include multiple predicted states that can represent the state information of the vehicle at a specific location along the candidate trajectory. State information may include location data, pose data (e.g., lateral offset data, longitudinal offset data, heading offset data), velocity data, acceleration data, and/or other types of data.

Based on generating the candidate trajectories, the planning component determine an overall cost for following the trajectory based on determining and/or combining a cost of traversing the trajectory (e.g., cost based on factors from within the trajectory horizon) and a cost-to-go to the destination (e.g., cost obtained from the local graph-cost based on factors beyond the trajectory horizon). The combination of the costs may be considered an overall cost and may be used to determine which of the multiple candidate trajectories to follow. Initially, the planning component may generate a tree structure that includes some or all of the candidate trajectories. A tree structure may include one or more nodes representing vehicle states at different action layers of the tree structure. Further, each vehicle state may include multiple candidate trajectories which the vehicle may follow. As described in more detail below, the planning component may use the tree structure to determine or otherwise select one or more of the candidate trajectories to follow within the environment. Example techniques for generating a tree structure and determining a control trajectory based on the tree structure can be found, for example, in U.S. application Ser. No. 17/900,658, filed Aug. 21, 2022, and titled “Trajectory Prediction Based on a Decision Tree,” the contents of which is herein incorporated by reference in its entirety and for all purposes.

In some examples, the vehicle can determine a control trajectory based on the tree structure. The vehicle can evaluate some or all candidate trajectories at each node when determining a control trajectory. A solution to the tree may result in a series of nodes of the one or more candidate trajectories which, when traversed (e.g., moving along and between differing trajectories), results in an output trajectory (e.g., control trajectory) having a lowest determined cost. A lowest determined cost for the output trajectory may represent and/or be indicative of the combination of one or more sub-costs. A cost value can indicate the safety, risk, convenience, and/or efficiency of a candidate trajectory. For instance, a high cost value may indicate heightened degree of risk, danger, inconvenience, and/or inefficiency of the trajectory. In contrast, a low cost value may indicate a lower degree of risk, danger, inconvenience, and/or inefficiency of the trajectory. As described above, sub-costs may include comfort related costs (e.g., acceleration cost, jerk cost, steering cost, path reference cost, etc.), legality related costs, policy related costs, safety related costs, progress costs, debris cost, a lane blocking cost, a lane ending cost, an exit cost, an approach cost, a space cost, a payment cost, a yaw cost, lane targeting cost (e.g., cost associated with the vehicle being located in a desired lane), and/or any other type of cost. Accordingly, the planning component may determine a lowest cost to transition (or follow the trajectory) to the end of the trajectory horizon. Additionally, the planning component may determine the cost-to-go to the destination using the local graph and combine such costs to determine an overall cost. As noted above, the overall cost may be used to determine which candidate trajectory to follow.

In some examples, the planning component may determine a cost-to-go to the destination for a candidate trajectory. The planning component may identify an end (or final) state of the candidate trajectory and project the end state onto the local graph. In some examples, the planning component may connect the end state of the candidate trajectory to the states of the local graph by generating (or otherwise associating) one or more new actions (e.g., action(s) not previously included in the local graph) between the end state of the candidate trajectory and the states of the local graph. Based on associating new action(s) to the local graph, the planning component may create edges from the end state to the action and additional edges from the action to any of the states within the local graph. In this example, the planning component may determine probabilities associated with transitioning to connected states based on the one or more action(s). Upon determining the transition probabilities, the planning component may determine a cost-to-go value corresponding to the end state of the candidate trajectory based on the transition probabilities, the cost-to-go values of the connecting states, transition cost(s), etc. Specifically, the planning component may determine the cost-to-go for the end state by using Equation 3 and/or Equation 4. Based on having determined the cost-to-go for the end state of the candidate trajectory, the planning component may combine (e.g., add costs together, weighted sum, etc.) the cost to transition to the end of the trajectory horizon with the cost-to-go to the destination. The combination of the two costs may be considered the overall cost. In some examples, the planning component may determine to follow a trajectory that has the lowest overall cost compared to the overall costs of other potential candidate trajectories.

In some examples, the vehicle may follow the control trajectory while operating within the environment. Upon determining the control trajectory from the tree search, the vehicle may follow the control trajectory throughout the environment.

The techniques described herein can improve the functioning, safety, and efficiency of the autonomous and semi-autonomous vehicles operating in various driving environments. Using local graph(s) to determine costs associated with traversing to the destination can enable the vehicle to determine efficient actions with respect to the destination. Specifically, such techniques may enable the vehicle to generate cost values that represent the cost associated with traversing the region covered by the candidate trajectory as well as regions beyond the scope of the candidate trajectory. Such costs can be leveraged to select trajectories that positively impact the vehicle in both the immediate and distant regions.

The techniques described herein may be implemented in several ways. Example implementations are provided below with reference to the following figures. Although discussed in the context of an autonomous vehicle, the methods, apparatuses, and systems described herein may be applied to a variety of systems, and are not limited to autonomous vehicles. In another example, the techniques may be utilized in an aviation or nautical context, or in any other system. Additionally, the techniques described herein may be used with real data (e.g., captured using sensor(s)), simulated data (e.g., generated by a simulator), or any combination of the two.

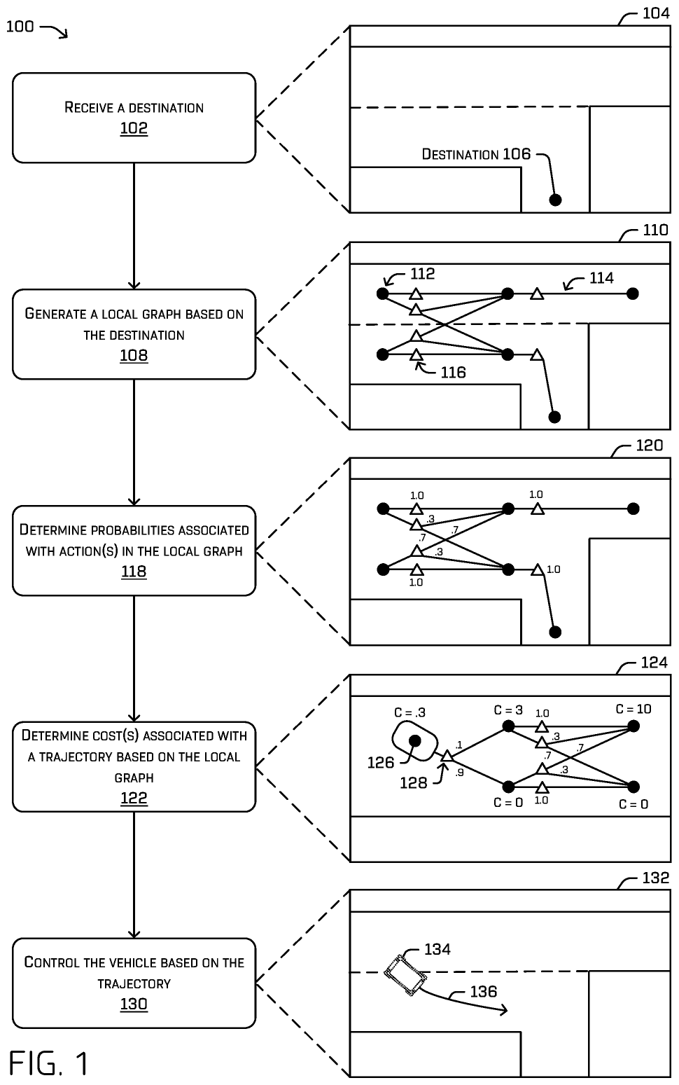

FIG. 1 is a pictorial flow diagram illustrating an example process 100 for determining a trajectory to follow based on a probabilistic graph. As shown in this example, some or all of the operations in the example process 100 may be performed by a perception component, prediction component, a planning component, and/or any other component or systems within an autonomous vehicle. For instance, as shown in this example, example process 100 may be implemented using a planning component. As described below in more detail, the planning component may include various components, such as a local graph component, a trajectory generating component, a trajectory cost component, and/or a trajectory determining component.

At operation 102, the planning component may receive a destination. In some examples, the planning component may receive instruction(s) that include a coordinate in the environment representing a destination to which the vehicle is to navigate. For example, box 104 illustrates a destination within an environment. In this example, the environment may include two driving lanes with one of the driving lanes separating from the other lane. As shown, the box 104 may include a destination 106 located within the environment. In this example, the destination 106 may be located within a driving lane; however, in other examples, the destination 106 may be the location of a building, a parking space, etc.

At operation 108, the planning component may generate a local graph based on the destination. In some examples, while navigating an environment, a vehicle may generate various candidate trajectories. To determine which of the trajectories to follow, the vehicle may determine cost(s) associated with the trajectories and select or otherwise determine the optimal (or most favorable) trajectory to follow. In some examples, the planning component may determine a local graph to determine and/or store cost values associated with navigating the environment such that the vehicle may be able to retrieve cost values effectively and/or efficiently when determining which trajectory to follow. A local graph may represent various driving lanes and/or lane segment(s) between the vehicle starting location and the destination. In some instances, the local graph may include state(s) (e.g., nodes), edge(s), action(s), probabilities, transition cost(s), and/or cost-to-go values associated thereto. For example, box 110 illustrates a local graph. In this example, box 110 may include a local graph that includes states 112 (e.g., black circles), edges 114 (e.g., lines connecting two states, and/or actions 116 (e.g., triangles located between states).

As shown in box 110, the local graph may include a plurality of states 112 located at various locations within the local graph. In this example, some states may be placed within a center portion of the driving lanes; however, in other examples, the states may be placed on the lane markers that define the boarders of the driving lanes. Further, box 110 illustrates a plurality of actions 116 located at various locations within the local graph. In this example, some actions may be placed within a center portion of the driving lanes while other actions are placed at a longitudinal and/or lateral offset. As shown, some actions may instruct the vehicle to remain in the same driving lane while other actions instruct the vehicle to change lanes.

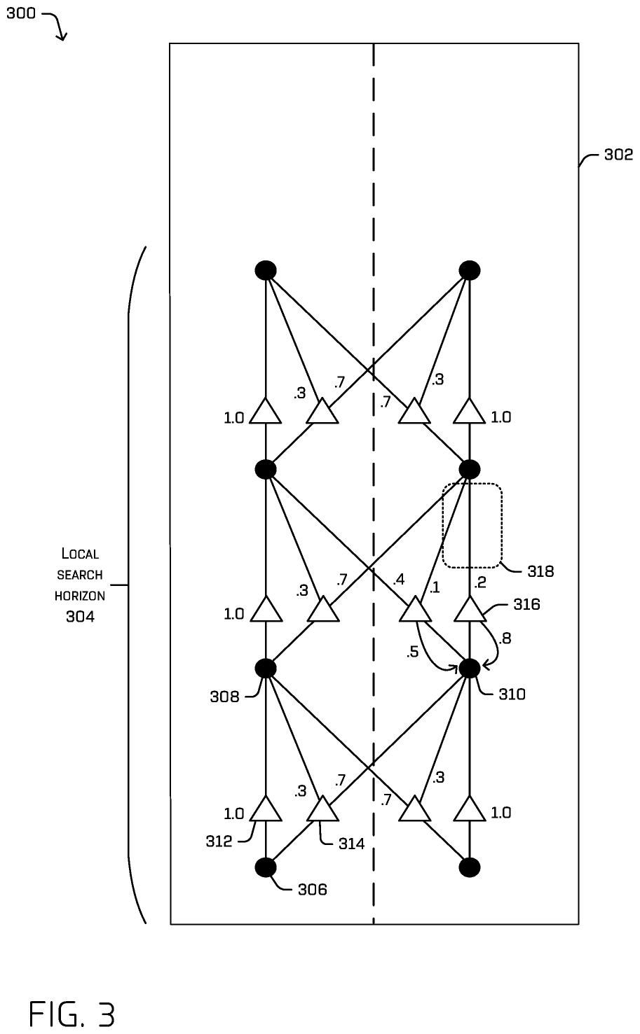

At operation 118, the planning component may determine probabilities associated with the actions 116 in the local graph. In some examples, based on including various actions a vehicle can perform at different locations along the local graph, the planning component may determine a probability that the vehicle may be able to perform the action (e.g., transition to an intended state) based on following a flow of traffic. The planning component may determine a probability associated with a transition of an action based on a variety of factors such as a distance between two nodes connected by the action (e.g., larger the distance the lower the probability), a time to navigate between two nodes connected by the action (e.g., larger the time the lower the probability), an object (e.g., any dynamic (e.g., pedestrian, vehicle, cyclist, etc.) or static (e.g., traffic cones, signs, etc.) objects) located at least partially between two nodes connected by the action (e.g., lower probability based on the presence of an object obstructing the path), a number of lane changes required by the transition (e.g., a larger number of lane changes may result in a lower probability), etc. Specifically, the planning component may use the Equation 1 and/or Equation 2 to determine the probability values. For example, box 120 illustrates the local graph as determined at operation 108 with transition probability values associated with the various actions. As shown, some actions may include a 1.0 probability value while others may have a 0.3 or a 0.7 probability value. However, this is not intended to be limiting; in other examples, the probability values may be the similar or different numbers. Additional description regarding determining probability values may be discussed in FIGS. 3 and 4.

At operation 122, the planning component may determine cost(s) associated with a trajectory based on the local graph. In some examples, based on having determined the transition probabilities associated with the actions at operation 118, the planning component may determine a cost-to-go from the states 112 in the local graph. Specifically, the planning component may determine a cost-to-go value for the terminal states (e.g., states at the end of the local search horizon) of the local graph and use such values to determine the cost-to-go values for the preceding states. The planning component may use Equations 3 and/or 4 to determine the cost-to-go for each state. For example, box 124 illustrates the local graph with cost values. That is, the top right state may have a cost-to-go of 10 while the bottom right state has a cost-to-go of 0. To determine the cost-to-go of the top left state, the planning component may identify the optimal policy (or action) between the multiple actions. In this example, the top left state has a first action with a transition probability of 1.0, a second action with a first option (or transition) having a transition probability of 0.3 and a second option (or transition) having a transition probability of 0.7. In this case, the planning component may determine whether the first action or the second action has a more favorable (e.g., lower) cost-to-go. The cost-to-go of the first action may be 10 (e.g., cost=1.0*10) and the cost of the second action may be 3 (e.g., cost=(0.3*10)+(0.7*0)). As such, based on the second action having a lower cost-to-go value, the planning component may associate the second action as the optimal policy and the cost-to-go associated thereto as the cost-to-go of the top left state. The planning component may perform similar operations for the remaining states.

In some examples, the planning component may generate one or more candidate trajectories for the vehicle to follow. As part of evaluating the candidate trajectories, the planning component may identify a cost-to-go value from the local graph to associate with the candidate trajectory. That is, the local graph may extend beyond the horizon (e.g., time horizon, search horizon, etc.) of the trajectory. As such, to obtain a better understanding about the quality of the trajectory, the planning component may determine a cost-to-go of the trajectory at an ending state of the trajectory. That is, the planning component may identify a final state of the trajectory and project the final state of the trajectory onto the local graph. The final state of the trajectory may be representative of the pose (e.g., position and/or orientation) of the vehicle at the final state. As shown, box 124 illustrates a final state 126 of the candidate trajectory. In some examples, the planning component may connect the final state 126 to the local graph by associating additional actions to the local graph. Of course, this is not intended to be limiting; in other examples, the planning component may add more than one action to the local graph. As shown in box 124, the planning component may add an action 128 to the local graph to enable the final state 126 to connect to one or more states of the local graph. In this example, the planning component may determine probability values associated with the transitions of action 128 based on the techniques described above.

In some examples, planning component may determine a cost-to-go for the final state 126 based on the action 128. The planning component may determine the cost-to-go for the final state 126 by performing Equations 3 and 4 from above. In this case, the planning component may determine the cost-to-go based on solving the equation, cost=(0.1*3)+(0.9*0). As such the cost-to-go for the final state 126 may be 0.3. In this example, based on identifying the cost-to-go for the final state 126, the planning component may associate the cost-to-go with the candidate trajectory. The planning component may consider and/or evaluate the cost-to-go value when determining which candidate trajectory to follow.

At operation 130, the planning component may control the vehicle based on the trajectory. As noted above, the planning component may compare the cost values of some or all of the candidate trajectories and determine which candidate trajectory to follow based on which trajectory has the most favorable cost value(s). For example, box 132 illustrates a vehicle 134 following a trajectory 136 based on the trajectory 136 having cost value(s) that were the lowest of the other candidate trajectories. In this example, the trajectory 136 may be instructing the vehicle 134 to perform a lane change maneuver. Of course, in other examples, the selected (or determined) trajectory may instruct the vehicle 134 to perform various other maneuvers.

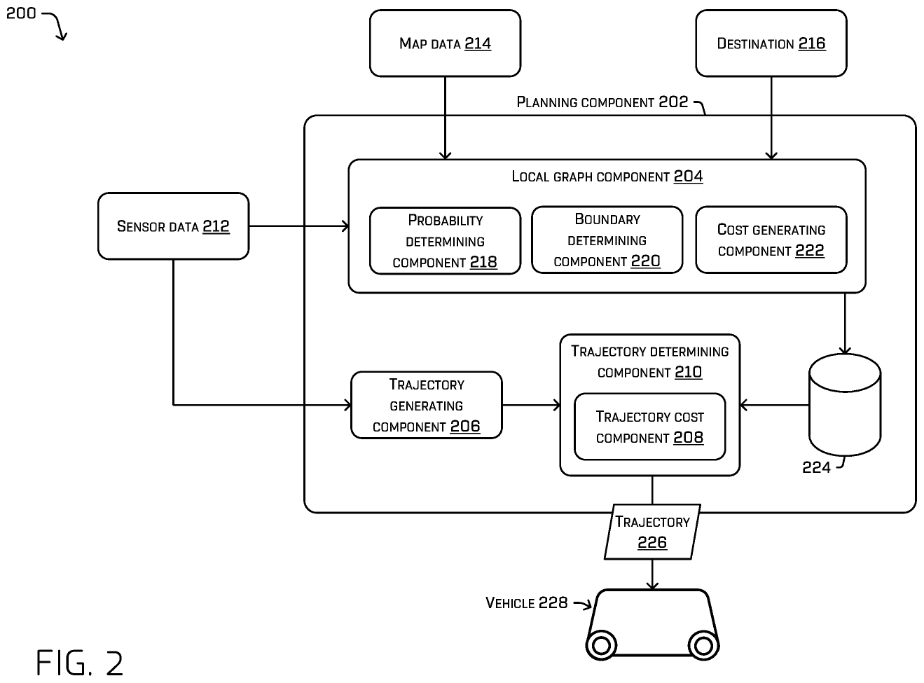

FIG. 2 illustrates an example computing system 200 including planning component 202 configured to generate and/or update local probabilistic graph(s) and use such graph(s) to determine a trajectory for a vehicle to follow.

In some examples, the planning component 202 may be similar or identical to the planning component described above, or in any other examples herein. As noted above, in some cases the planning component 202 may be implemented within an autonomous vehicle. In some examples, the planning component 202 may include various components, described below, configured to perform different functionalities of a technique to generate probabilistic graph(s) to associate cost(s) with candidate trajectories. In some examples, the planning component 202 may include a local graph component 204 configured to generate and/or update a local graph, a trajectory generating component 206 configured to generate one or more candidate trajectories for the vehicle to follow in the environment, a trajectory cost component 208 configured to generate a tree structure including the candidate trajectories and determine costs associated with such trajectories, and/or a trajectory determining component 210 configured to determine or otherwise select a candidate trajectory to follow.

In some examples, the planning component 202 may receive sensor data 212 from one or more sensor devices within (or otherwise associated with), perception components, and/or prediction components of the autonomous vehicle. As shown in FIG. 2, the sensor data 212 may be sent to the local graph component 204 and/or the trajectory generating component 206. In such instances, the sensor data 212 may represent the current driving scenario and/or the driving condition proximate the vehicle. The driving scenario may include vehicle information (e.g., trajectory data, (e.g., velocity, acceleration steering angle, etc.), pose data, etc.), object information (e.g., a trajectory of the object(s), a pose of the object(s), a number of object(s), a type of the object(s), a past trajectory of the object(s), etc.) and/or any other information.

In some examples, the planning component 202 may receive a destination 216 to which the vehicle is to travel. The planning component 202 may receive the destination 216 from one or more computing systems of the vehicle and/or from one or more external systems. The destination 216 may include an x-y coordinate (e.g., global coordinate frame or local coordinate frame) representing the location of the destination 216 within the environment. The destination 216 may be sent to the local graph component 204.

In some examples, the planning component 202 may receive map data 214 based on the destination 216. The planning component 202 may receive map data of the region of the environment between the starting location of the vehicle and the destination 216. In some examples, the planning component 202 may receive the map data 214 from an external map server, and/or may store the map data 214 in an internal storage. For instance, the autonomous vehicle may request a receive map data 214 from a remote map server, based on the destination 216 to which the vehicle is to travel, and store one or more maps locally on the vehicle. In some examples, map data 214 can include any number of data structures, modeled in two or more dimensions that are capable of providing information about the environment, such as, but not limited to, road network data, topologies, intersections, streets, roads, terrain, and the environment in general. The map data 214 may also represent various map features within the environment along the route, including but not limited to roads, lanes, curbs, shoulders, crosswalks, buildings, medians, street signs, traffic signs, speed limits, etc. In some examples, the map data 214 may be sent to the local graph component 204 within the planning component 202. Though shown that the local graph component 204 receives the map data 214, in other examples any other component of the planning component 202 may receive the map data 214.

In some examples, the planning component 202 may include a local graph component 204 configured to generate and/or update a local graph. The local graph component 204 may receive the sensor data 212, the map data 214, and/or the destination 216. As shown, the local graph component 204 may include one or more subcomponents such as the probability determining component 218, the boundary determining component 220, and/or the cost generating component 222. In some examples, the boundary determining component 220 may be configured to generate or otherwise determine the extent of the local graph. The local graph may be a subgraph of the entirety of the driving path to the destination. In some examples, the boundary determining component 220 may establish the local search horizon (e.g., extent) of the local graph based on the map data (e.g., driving lane data, lane segment data, etc.), the starting location of the vehicle, and/or the destination 216. In such cases, the boundary determining component 220 may place a plurality of nodes, a plurality of edges, a plurality of actions, etc. with the local graph. In such instances, the boundary determining component 220 may start the local search horizon at a node or set of nodes located immediately behind the autonomous vehicle. Further, the boundary determining component 220 may end the local search horizon at a node or set of nodes that are located a predetermined distance away from the start of the local search horizon. As stated above, the local search horizon may be 300 meters in distance. Thus, the boundary determining component 220 may identify a node or set of nodes that are approximately 300 meters from the start of the local search horizon. The boundary determining component 220 may determine the width of the local search horizon as the width of the local graph (e.g., width of the road network).

Based on determining the boundary of the local graph, the local graph component 204 may place nodes at various locations therein. When generating the local graph, the local graph component 204 may place one or more nodes (or states) at different locations along the local graph. For example, nodes can be placed at any location within a driving lane and/or at any location along a lane marker defining the boarder of a driving lane. Further, nodes may be placed at locations where new lanes begin, current lanes end, lanes change types, and/or any other location. Further, to ensure a dense graph, the local graph component 204 may also place nodes between and/or proximate two nodes where the distance between such nodes meets or exceeds a threshold distance. In such instances, the threshold distance may be 40 meters; however, in other such examples the threshold distance may be more or less than 40 meters. That is, if the local graph component 204 identifies a distance between two nodes is 40 meters or longer, the local graph component 204 may place a node between the two nodes.

In some examples, the local graph component 204 may generate directed edges to connect the nodes. For example, the local graph component 204 may connect two nodes with a directed edge. The directed edge may be a kinematically feasible or non-kinematically feasible vehicle transition that illustrates the direction and/or angle of travel. The local graph component 204 may generate, for a single node, one or more directed edges entering the node (e.g., candidate paths for a vehicle to navigate to the node) and/or one or more directed edges leaving the node (e.g., candidate paths for a vehicle to navigate from the node). In some examples, the edges may include various types of data, such as location data, heading data, etc.

In some examples, the probability determining component 218 may be configured to determine probability values associated with transitions of actions within the local graph. In some cases, the local graph component 204 may place one or more actions at various locations within the local graph. The actions may be located at a same location as the nodes (or states). However, in other examples, the actions may be between two states at varying lateral and/or longitudinal offsets. The actions may include a lane change action and/or a remain in lane action. Accordingly, the probability determining component 218 may determine a probability (or transition probability) that the vehicle may be able to perform the transition associated with action based on the vehicle following the flow of traffic. In such cases, the probability determining component 218 may determine the probability based on Equations 1 and 2 described above.

In some examples, the cost generating component 222 may be configured to generate a cost-to-go value for some or all states within the local graph. The cost-to-go value may represent a cost for the vehicle to travel from a state in the local graph to the boundary of the local search horizon or to the destination 216. Initially, the cost generating component 222 may determine a cost-to-go value for the terminal states. A terminal state may be a state that is located at the end of the local search horizon, a state that lacks edges leaving the state, etc. The cost generating component 222 may determine the cost-to-go for such terminal states based on a combination of one or more of the sub-costs described above. Based on determining the cost-to-go for the terminal states, the cost generating component 222 may use such data along with the probability values for the states to determine the cost-to-go for the states preceding the terminal states. When determining the cost-to-go for such states (e.g., non-terminal states), the cost generating component 222 may perform the operations described in Equations 3 and 4. Accordingly, the cost generating component 222 may determine a cost-to-go for each state within the local graph. In some examples, the cost generating component 222 and/or any other component of the planning component 202 may store the local graph with the associated cost-to-go values in a database 224. In such examples, the vehicle can access the database 224 when determining cost(s) for candidate trajectories.

In some examples, the planning component 202 may include a trajectory generating component 206 configured to generate one or more candidate trajectories for the vehicle to follow in the environment. The trajectory generating component 206 may receive sensor data 212 indicative of the current driving scenario. Though not shown, the trajectory generating component 206 may also receive the map data 214 and/or the destination 216. Examples of various techniques for generating planner trajectories for autonomous vehicles can be found, for example, in U.S. Pat. No. 10,921,811, filed on Jan. 22, 2018, issued on Feb. 16, 2021, and titled, “Adaptive Autonomous Vehicle Planner Logic,” and U.S. Pat. No. 10,955,851, filed on Feb. 14, 2018, issued on Mar. 23, 2021, and titled, “Detecting Blocking Objects,” each of which is incorporated by reference herein in its entirety.

In some examples, the planning component 202 may include a trajectory determining component 210 that includes a trajectory cost component 208. The trajectory cost component 208 may be configured to generate a tree structure including the candidate trajectories and determine costs associated with such trajectories. The trajectory cost component 208 may receive the candidate trajectories from the trajectory generating component 206. In some examples, the trajectory cost component 208 may generate a tree structure that includes some or all of the candidate trajectories. The purpose of the tree structure is to enable the vehicle to evaluate the candidate trajectories at each state of the vehicle and to determine a control trajectory for the vehicle to follow based on such candidate trajectories. The tree structure may include an initial node (e.g., root node) which represents the state of the vehicle. Multiple candidate trajectories may extend from the initial node. In such instances, the trajectory cost component 208 may determine a traversal path based on the candidate trajectories that results in the traversal path having a lowest determined overall cost. Part of the overall cost of a candidate trajectory may be a cost-to-go value from the local graph. As such, the trajectory cost component 208 may utilize the local graph stored in the database 224 to retrieve cost-to-go values to associate with the candidate trajectories.

In some examples, the trajectory cost component 208 may retrieve and/or determine a cost-to-go value from the local graph to associate with a candidate trajectory. For example, the trajectory cost component 208 may identify a final (or ending) state of the candidate trajectory and project the final state onto the local graph that may be stored within the database 224. In some examples, the trajectory cost component 208 may connect the final state of the candidate trajectory to the nodes of the local graph by incorporating one or more new actions and/or edges leading to one or more nodes of the local graph. Based on adding new actions and/or edges, the trajectory cost component 208 may use Equations 1 and 2 described above to determine a probability associated with the transitions of such actions. Accordingly, based on connecting the final state of the candidate trajectory to the states of the local graph, the trajectory cost component 208 may determine a cost-to-go for the final state of the candidate trajectory by using Equations 3 and/or 4. In such examples, the trajectory cost component 208 may associate the cost-to-go determined by Equations 3 and/or 4 with the final state of the candidate trajectory and/or with the trajectory as a whole. As noted above, the cost-to-go may be a factor into the overall cost value of the candidate trajectory. In such cases, the trajectory determining component 210 may be configured to determine or otherwise select a candidate trajectory to follow based on the overall cost values. In this example, the trajectory determining component 210 may select the candidate trajectory with the most favorable (e.g., lowest based on low cost values being indicative of a favorable cost) overall cost value. The trajectory determining component 210 may send the trajectory 226 to the vehicle 228 for the vehicle 228 to follow. In such instances, upon receiving the trajectory 226, the vehicle 228 may be controlled, based on the instructions included in the trajectory 226, to follow the trajectory 226 throughout the environment.

FIG. 3 depicts an example environment 300 and an example local graph 302 that includes a local search horizon, modified probabilities based on environmental factors, and/or an alternative action based on an object blocking at least a portion of a driving lane.

In this example, the example environment 300 may include a driving environment associated with a local graph 302. As shown, the local graph 302 may extend a portion of the environment. That is, when determining the local graph 302, the planning component may determine the boundaries (or extent) of the local graph 302 which may be represented by the local search horizon 304. As noted above, the local search horizon 304 may be the region within which the planning component may place states, edges, and/or actions. In some examples, the planning component may update the local graph according to a predetermined frequency. That is, the planning component may update the local graph while the vehicle traverses the environment according to an operating tick (e.g., every 1 millisecond, every 5 milliseconds, etc.) of the planning component. When the planning component updates the local graph, the planning component may shift (towards the destination and/or in the direction of the vehicle travel) the boundaries of the local search horizon 304 such that the local search horizon 304 continues to extend a threshold distance in front of the vehicle. Accordingly, when the planning component updates the local graph, the planning component may add new states, edges, and/or actions to the local graph.

As shown, in the local graph 302 may include multiple states, edges, actions, and/or probabilities. For example, the local graph 302 may include a state 306, a state 308, and a state 310 among others. In this examples, the local graph 302 may include actions between the states indicating driving maneuvers (or transitions) a vehicle may perform upon arriving at the state or at the action location. That is, the local graph 302 may include an action 312, an action 314, and an action 316 among others. In this case, the action 312 may be a stay in lane action with a 1.0 probability value of the vehicle transitioning to the state 308. The action 314 may include an option (or transition) to travel to state 308 and an option (or transition) to travel to state 310. The option to transition to state 308 may have a probability value of 0.3 and the option to transition to state 310 may have a probability value of 0.7. Further, the action 316 may be a self-cycle action which instructs the vehicle to reduce velocity below a threshold (e.g., stop) and/or return to the state 310. As shown, the action 316 may include a self-cycle option (or transition) with a probability of 0.8 and an option to continue navigating in-lane to the next state.

In some examples, the probabilities associated with the transitions of the actions may represent the probability of transitioning to the intended state based on the flow of traffic (e.g., velocity of traffic flow). As noted above, the planning component may determine the probabilities using Equations 1 and 2 described above. However, as noted above, the planning component may modify probability values based on a variety of factors such as a distance between nodes connected by the action (e.g., the larger the distance the lower the probability), a travel time between nodes connected by the action (e.g., the larger the travel time the lower the probability), and/or the detection of an object within a lane. That is, the vehicle may receive sensor data from one or more sensor devices (e.g., lidar device(s), radar device(s), time-of-flight device(s), image capturing device(s), etc.). In this example, the vehicle may analyze the sensor data and detect one or more object(s) blocking at least a portion of a driving lane. As such, the planning component may modify (or update) the local graph by changing the probabilities associated with the transitions of actions that are impacted by the object. For example, in FIG. 3, the vehicle may detect an object 318 may be blocking a driving lane. As such, based on the object 318 blocking the lane, the planning component may add the action 316 (e.g., self-cycle action) and/or modify the probabilities of the transitions of other actions associated with the state 310. As shown, the planning component may modify the probability associated with the transition of state 310 to be 0.1, modifying the other probability to be 0.4, and/or adding a second self-cycle action with a transition probability of 0.5. Though it is described that the planning component may modify the probability values (or local graph) based on sensor data, in other examples, the planning component may modify the local graph based on map data. That is, the planning component may receive information from the map data that indicates the vehicle is approaching a construction zone (or any other type of traffic zone) in which a driving lane is blocked. In this case, the planning component may remove some or all states and/or actions from within the blocked lane. However, in other examples, the planning component may modify the probabilities and/or costs of the transitions associated with the actions and/or states within the blocked lane such that the vehicle does not navigate into the blocked lane. In some examples, the planning component may use the local graph 302 and the data stored therein to determine cost-to-go values that can be accessible when determining among candidate trajectories.

FIG. 4 illustrates an example scenario 400 for determining the optimal policy (or action) based on a local graph.

In this example, FIG. 4 may include a box 426 that includes a driving environment and/or a local graph. As shown, the local graph may include one or more states, edges, actions, probabilities, transition cost(s), and/or cost-to-go values. That is, the local graph may include a state 412 and a state 406 which may be terminal states since such states lack edges leaving from the state. Further, the local graph may include a state 402, a state 404, a state 408, and a state 410. In such examples, the various states may be connected by one or more edges (or transitions). As shown, the local graph may also include one or more actions located between two states. For example, the local graph may include an action 414 (with a transition probability of 1.0) to navigate to state 412, an action 416 (with a transition probability of 1.0) to navigate to state 402, an action 418 with the option to navigate to state 402 (with transition probability of 0.3) or to state 408 (with a transition probability of 0.7), an action 420 with the option to navigate to state 402 (with a transition probability of 0.7) or to state 408 (with a transition probability of 0.3), and action 422 (with a transition probability of 1.0) to navigate to state 408, and an action 424 (with a transition probability of 1.) to navigate to state 406. However, this is not intended to be limiting; in other examples, the local graph may include more or fewer actions with differing transition probability values.

As shown in FIG. 4, the planning component may determine a transition cost (shown as “TC” in FIG. 4) associated with the cost to transition from one state to another. In this example, the transition cost associated with transitioning from state 410 to state 408 may be 3.0, the transition cost associated with transitioning from state 410 to state 402 may be 4.0, the transition cost associated with transitioning from state 404 to state 402 may be 3.0, the transition cost associated with transitioning from state 404 to state 408 may be 4.0, the transition cost associated with transitioning from state 408 to state 406 may be 3.0, and the transition cost associated with transitioning from state 402 to state 412 may be 3.0. Of course, in other examples, the transition costs may be similar or different numbers. As noted above, The planning component may determine the transition cost(s) based on various factors such as a distance to travel between the two nodes connected by the action (e.g., larger distance may result in a higher transition cost), a time to transition between the two nodes connected by the action (e.g., higher transition times may result in higher cost values), the proximity of an object to the node to which the vehicle may transition (e.g., an object located close to (e.g., within a threshold range) the node may result in a larger transition cost), the number of lane changes required by the transition (e.g., more lane changes may result in a higher transition cost), and/or any other factor.

As shown in table 428, the planning component may determine a cost-to-go for each of the states within the local graph using Equations 3 and/or 4. Specifically, the planning component may determine a cost-to-go for the terminal states which may be state 412 and state 406. In such cases, the planning component may determine one or more sub-costs and combine such sub-costs into a combined, cost-to-go. As shown, the cost-to-go of the state 412 may be 0 and the cost-to-go of the state 406 may be 10. After determining such cost-to-go values, the planning component may determine cost-to-go values for the non-terminal states. In this example, the table 428 indicates the math associated with determining the cost-to-go for the remaining states. That is, to determine the cost-to-go for state 402, the planning component may multiply the transition probability of the action 414 (e.g., 1.0) with the cost-to-go of state 412 (e.g., 0) plus the transition cost of 3.0 (e.g., 1.0*(3.0+0)). In this case, the cost-to-go of state 402 may be 3. Further, to determine the cost-to-go for the state 408, the planning component may multiply the transition probability of the action 424 (e.g., 1.0) with the cost-to-go of the state 406 (e.g., 10) plus the transition cost of 3.0 (e.g., 1.0*(3.0+10)). In this case, the cost-to-go of state 408 may be 13.

In some cases, to determine the cost-to-go for the state 404, the planning component may identify the optimal policy (or action) between the action 416 and the action 418. As such, the planning component may determine the cost-to-go for the action 416 and the cost-to-go for the action 418 and determine which action is the optimal policy based on which cost-to-go is most favorable (e.g., lower). Here, the cost-to-go for the action 416 may be determined by multiplying the transition probability of the action 416 (e.g., 1.0) with the cost-to-go of the state 402 (e.g., 3) plus the transition cost of 3.0 (e.g., 1.0*(3+3)). In this case, the cost-to-go of state 404 may be 6 based on the action 416. The cost-to-go for the action 418 may be determined by multiplying the transition probability of the action 418 leading to state 408 (e.g.,.7) with the cost-to-go of the state 408 (e.g., 13) plus the transition cost of 4.0 (e.g., 7.0*(13+4)), the result of which being added the result of multiplying the transition probability of the action 418 leading to state 402 (e.g., 0.3) with the cost-to-go of the state 402 (e.g., 3) plus the transition cost of 3.0 (e.g., 0.3*(3.0+3)). In this case, the cost-to-go of state 404 may be 13.7 based on the action 418. As such, the optimal policy for the state 404 may be determined by comparing the cost-to-go values for the action 416 (e.g., 6) with the cost-to-go value of action 418 (e.g., 13.7). Based on the cost-to-go of action 416 being more favorable (e.g., less than the cost-to-go of action 418), the planning component may associate the cost-to-go of following action 416 as the cost-to-go for the state 404.

To determine the cost-to-go for the state 410, the planning component may identify the optimal policy (or action) between the action 422 and the action 420. As such, the planning component may determine the cost-to-go for the action 422 and the cost-to-go for the action 420 and determine which action is the optimal policy based on which cost-to-go is most favorable. Here, the cost-to-go for the action 422 may be determined by multiplying the transition probability of the action 422 (e.g., 1.0) with the cost-to-go of the state 408 (e.g., 13) plus the transition cost of 3.0 (e.g., 1.0*(13+3)). In this case, the cost-to-go of state 410 may be 16 based on the action 422. The cost-to-go for the action 420 may be determined by multiplying the transition probability of the action 420 leading to state 408 (e.g., 0.3) with the cost-to-go of the state 408 (e.g., 13) plus the transition cost of 3.0 (e.g., 0.3*(13+3)), the result of which being added to the result of multiplying the transition probability of the action 420 leading to state 402 (e.g., 0.7) with the cost-to-go of the state 402 (e.g., 3) plus the transition cost of 4.0 (e.g., 0.7*(4.0+3)). In this case, the cost-to-go of state 410 may be 9.7 based on the action 420. As such, the optimal policy for the state 410 may be determined by comparing the cost-to-go values for the action 422 (e.g., 16) with the cost-to-go value of action 420 (e.g., 9.7). Based on the cost-to-go of action 420 being more favorable (e.g., lower), the planning component may associate the cost-to-go of following action 420 as the cost-to-go for the state 410.

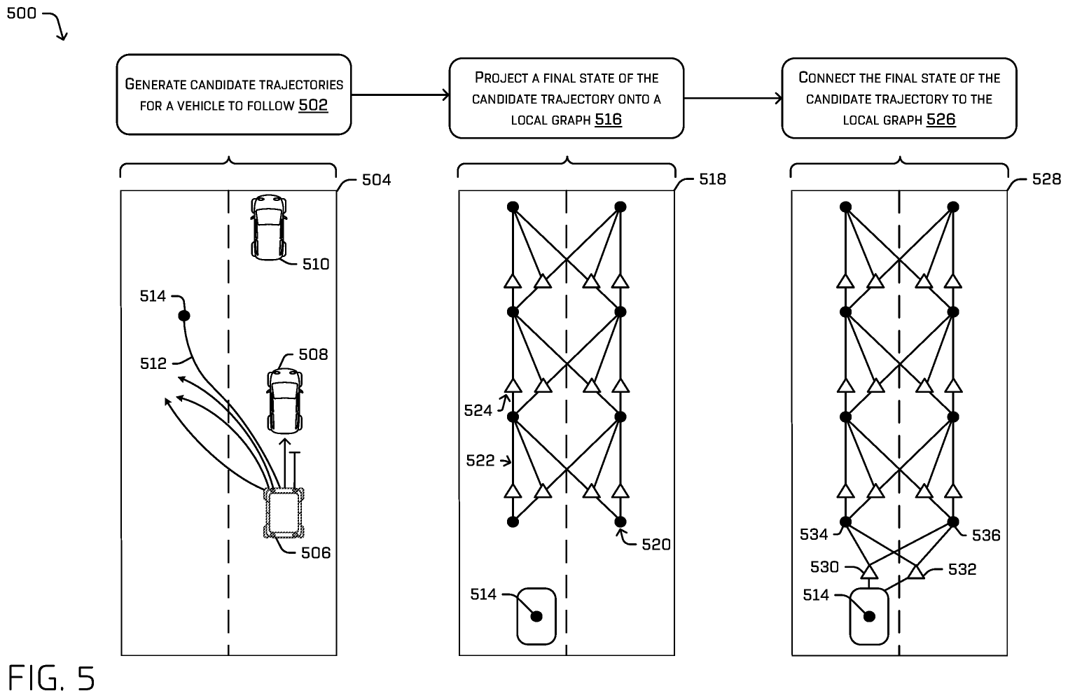

FIG. 5 is a pictorial flow diagram illustrating an example process 500 for determining a cost associated with a candidate trajectory based on accessing a local graph. As describe above, some or all the operations in the example process 500 may be performed by a planning component that are similar or identical to the planning component 202 as described throughout.

At operation 502, the planning component may generate candidate trajectories for a vehicle to follow. In this example, box 504 illustrates an autonomous vehicle 506 navigating behind an object 508 and an object 510. As shown, the object 508 and the object 510 may be vehicles; however, in other examples the object 508 and the object 510 may be any other dynamic or static objects. In this example, the autonomous vehicle 506 may include multiple candidate trajectories for the vehicle to follow. Such candidate trajectories may include trajectories instructing the vehicle 506 to perform a left lane change, a trajectory instructing the vehicle 506 to remain within the same lane at a similar velocity, a trajectory instructing the vehicle 506 to remain within the same lane a reduce velocity, among others. Specifically, the vehicle 506 may include a candidate trajectory 512 that instructs the vehicle to perform a left lane change maneuver. To determine which of the candidate trajectories to follow, the planning component may determine the cost associated with following such trajectories. As shown, the candidate trajectory 512 may include a final state 514 which may represent a state (e.g., pose, velocity, acceleration, steering angle, etc.) of the vehicle 506 at that position if the vehicle 506 follows the candidate trajectory 512.

At operation 516, the planning component may project the final state of the candidate trajectory onto the local graph. In some examples, the planning component may generate and/or update a local graph that includes cost-to-go values associated with the vehicle performing various driving maneuvers at various locations within the environment. The planning component may use the local graph to retrieve cost-to-go values when evaluating which candidate trajectory to follow. For example, box 518 illustrates a local graph with a plurality of states 520, a plurality of edges 522, a plurality of actions 524, and/or a plurality of cost-to-go values (not shown) associated with the plurality of states 520. To determine and/or retrieve the cost-to-go values from the local graph, the planning component may project the final state 514 onto the local graph. As shown, box 518 includes the final state 514 of the candidate trajectory 512. As noted above, the final state 514 may represent a location and/or orientation of the vehicle 506 at the end of the candidate trajectory 512.

At operation 526, the planning component may connect the final state of the candidate trajectory to the local graph. That is, due to the final state 514 not being at the exact location of one of the plurality of states 520, the planning component may connect the final state 514 to the local graph such that the planning component may be able to determine an accurate cost-to-go value. The planning component may connect the final state 514 to the local graph by incorporating additional action(s) and/or edge(s) while also determining probabilities associated with such action(s). For example, box 528 illustrates new actions and/or edges connecting the final state 514 to one or more states within the local graph. In this example, the planning component may add an action 530 and an action 532. In this example, the action 530 may be located within the same driving lane as the final state 514 and may include options to navigate to the state 534 or to the state 536. The action 532 may be located in a laterally adjacent (and different) lane from the lane within which the final state 514 is located. Further, the action 532 may include options to navigate to the state 534 or to the state 536. However, this is not intended to be limiting; in other examples, the planning component may add more or fewer actions and each action may include more or fewer options (or edges) leading to any state in the local graph. Though not shown, the planning component may determine probabilities associated with the vehicle 506 performing the transitions of the action(s). Based on connecting the final state 514 to the local graph, the planning component may determine a cost-to-go for the final state 514 by using Equations 3 and/or 4.

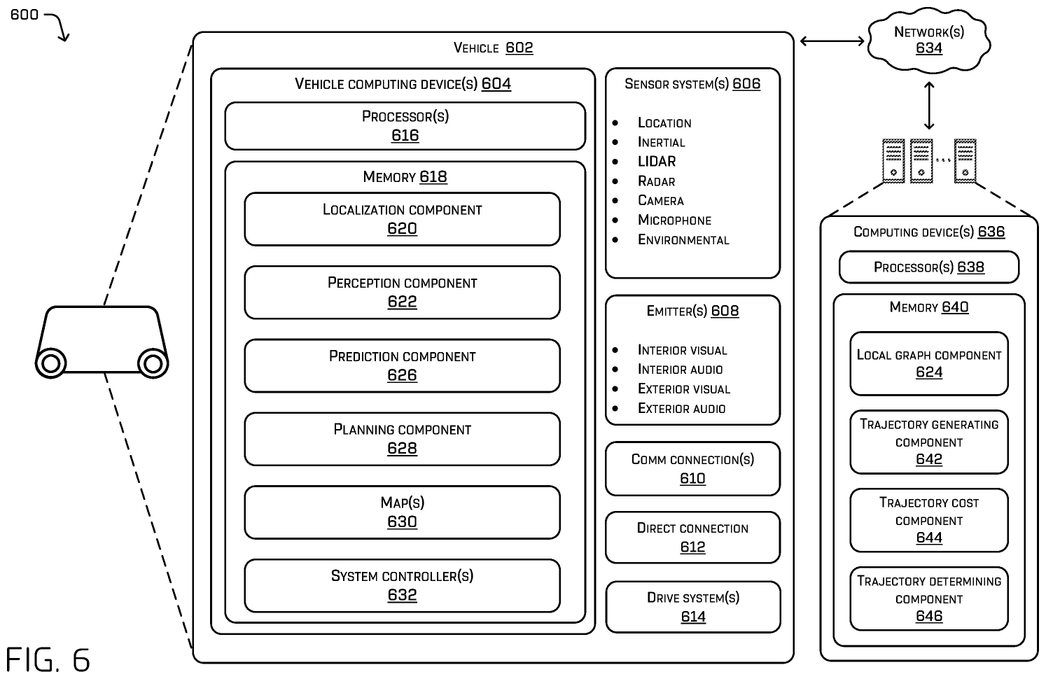

FIG. 6 is a block diagram of an example system 600 for implementing the techniques described herein. In at least one example, the system 600 may include a vehicle, such as vehicle 602. The vehicle 602 may include one or more vehicle computing devices 604, one or more sensor systems 606, one or more emitters 608, one or more communication connections 610, at least one direct connection 612, and one or more drive systems 614.

The vehicle computing device 604 may include one or more processors 616 and memory 618 communicatively coupled with the processor(s) 616. In the illustrated example, the vehicle 602 is an autonomous vehicle; however, the vehicle 602 could be any other type of vehicle, such as a semi-autonomous vehicle, or any other system having at least an image capture device (e.g., a camera-enabled smartphone). In some instances, the autonomous vehicle 602 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 602 may be a fully or partially autonomous vehicle having any other level or classification.

In the illustrated example, the memory 618 of the vehicle computing device 604 stores a localization component 620, a perception component 622, a prediction component 626, a planner component 628, one or more system controllers 632, and one or more maps 630 (or map data). Though depicted in FIG. 6 as residing in the memory 618 for illustrative purposes, it is contemplated that the localization component 620, the perception component 622, the prediction component 626, the planner component 628, system controller(s) 632, and/or the map(s) may additionally, or alternatively, be accessible to the vehicle 602 (e.g., stored on, or otherwise accessible by, memory remote from the vehicle 602, such as, for example, on memory 640 of one or more computing device 636 (e.g., a remote computing device)). In some examples, the memory 640 may include a local graph component 624, a trajectory generating component 642, a trajectory cost component 644, and/or a trajectory determining component 646.

In at least one example, the localization component 620 may include functionality to receive sensor data from the sensor system(s) 606 to determine a position and/or orientation of the vehicle 602 (e.g., one or more of an x-, y-, z-position, roll, pitch, or yaw). For example, the localization component 620 may include and/or request/receive a map of an environment, such as from map(s) 630, and may continuously determine a location and/or orientation of the vehicle 602 within the environment. In some instances, the localization component 620 may utilize SLAM (simultaneous localization and mapping), CLAMS (calibration, localization and mapping, simultaneously), relative SLAM, bundle adjustment, non-linear least squares optimization, or the like to receive image data, lidar data, radar data, inertial measurement unit (IMU) data, GPS data, wheel encoder data, and the like to accurately determine a location of the vehicle 602. In some instances, the localization component 620 may provide data to various components of the vehicle 602 to determine an initial position of the vehicle 602 for determining the relevance of an object to the vehicle 602, as discussed herein.

In some instances, the perception component 622 may include functionality to perform object detection, segmentation, and/or classification. In some examples, the perception component 622 may provide processed sensor data that indicates a presence of an object (e.g., entity) that is proximate to the vehicle 602 and/or a classification of the object as an object type (e.g., car, pedestrian, cyclist, animal, building, tree, road surface, curb, sidewalk, unknown, etc.). In some examples, the perception component 622 may provide processed sensor data that indicates a presence of a stationary entity that is proximate to the vehicle 602 and/or a classification of the stationary entity as a type (e.g., building, tree, road surface, curb, sidewalk, unknown, etc.). In additional or alternative examples, the perception component 622 may provide processed sensor data that indicates one or more features associated with a detected object (e.g., a tracked object) and/or the environment in which the object is positioned. In some examples, features associated with an object may include, but are not limited to, an x-position (global and/or local position), a y-position (global and/or local position), a z-position (global and/or local position), an orientation (e.g., a roll, pitch, yaw), an object type (e.g., a classification), a velocity of the object, an acceleration of the object, an extent of the object (size), etc. Features associated with the environment may include, but are not limited to, a presence of another object in the environment, a state of another object in the environment, a time of day, a day of a week, a season, a weather condition, an indication of darkness/light, etc.

The prediction component 626 may generate one or more probability maps representing prediction probabilities of possible locations of one or more objects in an environment. For example, the prediction component 626 may generate one or more probability maps for vehicles, pedestrians, animals, and the like within a threshold distance from the vehicle 602. In some instances, the prediction component 626 may measure a track of an object and generate a discretized prediction probability map, a heat map, a probability distribution, a discretized probability distribution, and/or a trajectory for the object based on observed and predicted behavior. In some instances, the one or more probability maps may represent an intent of the one or more objects in the environment.

In some examples, the prediction component 626 may generate predicted trajectories of objects (e.g., objects) in an environment. For example, the prediction component 626 may generate one or more predicted trajectories for objects within a threshold distance from the vehicle 602. In some examples, the prediction component 626 may measure a trace of an object and generate a trajectory for the object based on observed and predicted behavior. Additionally, the prediction component 626 may be perform any of the techniques described with respect to any of FIGS. 1-6 above with respect to receiving, retrieving, determining, and/or generating predicted trajectories for object(s) within the environment.

In general, the planner component 628 may determine a path for the vehicle 602 to follow to traverse through an environment. For example, the planner component 628 may determine various routes and trajectories and various levels of detail. For example, the planner component 628 may determine a route to travel from a first location (e.g., a current location) to a second location (e.g., a target location). For the purpose of this discussion, a route may include a sequence of waypoints for travelling between two locations. As non-limiting examples, waypoints include streets, intersections, global positioning system (GPS) coordinates, etc. Further, the planner component 628 may generate an instruction for guiding the vehicle 602 along at least a portion of the route from the first location to the second location. In at least one example, the planner component 628 may determine how to guide the vehicle 602 from a first waypoint in the sequence of waypoints to a second waypoint in the sequence of waypoints. In some examples, the instruction may be a candidate trajectory, or a portion of a trajectory. In some examples, multiple trajectories may be substantially simultaneously generated (e.g., within technical tolerances) in accordance with a receding horizon technique. A single path of the multiple paths in a receding data horizon having the highest confidence level may be selected to operate the vehicle. In various examples, the planner component 628 may select a trajectory for the vehicle 602.

In other examples, the planner component 628 may alternatively, or additionally, use data from the localization component 620, the perception component 622, and/or the prediction component 626 to determine a path for the vehicle 602 to follow to traverse through an environment. For example, the planner component 628 may receive data (e.g., object data) from the localization component 620, the perception component 622, and/or the prediction component 626 regarding objects associated with an environment. In some examples, the planner component 628 receives data for relevant objects within the environment. Using this data, the planner component 628 may determine a route to travel from a first location (e.g., a current location) to a second location (e.g., a target location) to avoid objects in an environment. In at least some examples, such a planner component 628 may determine there is no such collision-free path and, in turn, provide a path that brings vehicle 602 to a safe stop avoiding all collisions and/or otherwise mitigating damage. Further, the planner component 628 may perform similar or identical operations as the planning component 202 as described throughout with respect to any of FIGS. 1-5.

In at least one example, the vehicle computing device 604 may include one or more system controllers 632, which may be configured to control steering, propulsion, braking, safety, emitters, communication, and other systems of the vehicle 602. The system controller(s) 632 may communicate with and/or control corresponding systems of the drive system(s) 614 and/or other components of the vehicle 602.

The memory 618 may further include one or more maps 630 that may be used by the vehicle 602 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some examples, the vehicle 602 may be controlled based at least in part on the map(s) 630. That is, the map(s) 630 may be used in connection with the localization component 620, the perception component 622, the prediction component 626, and/or the planner component 628 to determine a location of the vehicle 602, detect objects in an environment, generate routes, determine actions and/or trajectories to navigate within an environment.

In some examples, the one or more maps 630 may be stored on a remote computing device(s) (such as the computing device(s) 636) accessible via network(s) 634. In some examples, multiple maps 630 may be stored based on, for example, a characteristic (e.g., type of entity, time of day, day of week, season of the year, etc.). Storing multiple maps 630 may have similar memory requirements, but increase the speed at which data in a map may be accessed.

In some instances, aspects of some or all of the components discussed herein may include any models, techniques, and/or machine-learned techniques. For example, in some instances, the components in the memory 618 (and the memory 640, discussed below) may be implemented as a neural network.

As described herein, an exemplary neural network is a technique which passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

Additional examples of architectures include neural networks such as ResNet-50, ResNet-101, VGG, DenseNet, PointNet, Xception, ConvNext, and the like; visual transformer(s) (ViT(s)), such as a bidirectional encoder from image transformers (BEIT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/963,833, which is incorporated by reference in its entirety herein for all purposes), and/or VoxelNet. Architecture latency optimizations may include Mobilenet V2, Shufflenet, Channelnet, Pelcenet, and/or the like. The ML model may comprise a residual block such as Pixor, in some examples.

In at least one example, the sensor system(s) 606 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 606 may include multiple instances of each of these or other types of sensors. For instance, the lidar sensors may include individual lidar sensors located at the corners, front, back, sides, and/or top of the vehicle 602. As another example, the camera sensors may include multiple cameras disposed at various locations about the exterior and/or interior of the vehicle 602. The sensor system(s) 606 may provide input to the vehicle computing device 604. Additionally, or in the alternative, the sensor system(s) 606 may send sensor data, via the one or more networks 634, to the one or more computing device(s) 636 at a particular frequency, after a lapse of a predetermined period of time, in near real-time, etc.

The vehicle 602 may also include one or more emitters 608 for emitting light and/or sound. The emitter(s) 608 may include interior audio and visual emitters to communicate with passengers of the vehicle 602. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 608 may also include exterior emitters. By way of example and not limitation, the exterior emitters may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 602 may also include one or more communication connections 610 that enable communication between the vehicle 602 and one or more other local or remote computing device(s). For instance, the communication connection(s) 610 may facilitate communication with other local computing device(s) on the vehicle 602 and/or the drive system(s) 614. Also, the communication connection(s) 610 may allow the vehicle to communicate with other nearby computing device(s) (e.g., computing device 636, other nearby vehicles, etc.) and/or one or more remote sensor system(s) for receiving sensor data. The communications connection(s) 610 also enable the vehicle 602 to communicate with a remote teleoperations computing device or other remote services.

The communications connection(s) 610 may include physical and/or logical interfaces for connecting the vehicle computing device 604 to another computing device or a network, such as network(s) 634. For example, the communications connection(s) 610 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 602 may include one or more drive systems 614. In some examples, the vehicle 602 may have a single drive system 614. In at least one example, if the vehicle 602 has multiple drive systems 614, individual drive systems 614 may be positioned on opposite ends of the vehicle 602 (e.g., the front and the rear, etc.). In at least one example, the drive system(s) 614 may include one or more sensor systems to detect conditions of the drive system(s) 614 and/or the surroundings of the vehicle 602. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 614. In some cases, the sensor system(s) on the drive system(s) 614 may overlap or supplement corresponding systems of the vehicle 602 (e.g., sensor system(s) 606).

The drive system(s) 614 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 614 may include a drive module controller which may receive and preprocess data from the sensor system(s) and to control operation of the various vehicle systems. In some examples, the drive module controller may include one or more processors and memory communicatively coupled with the one or more processors. The memory may store one or more modules to perform various functionalities of the drive system(s) 614. Furthermore, the drive system(s) 614 may also include one or more communication connection(s) that enable communication by the respective drive module with one or more other local or remote computing device(s).

In at least one example, the direct connection 612 may provide a physical interface to couple the one or more drive system(s) 614 with the body of the vehicle 602. For example, the direct connection 612 may allow the transfer of energy, fluids, air, data, etc. between the drive system(s) 614 and the vehicle. In some instances, the direct connection 612 may further releasably secure the drive system(s) 614 to the body of the vehicle 602.

In at least one example, the localization component 620, the perception component 622, the prediction component 626, the planner component 628, the one or more system controllers 632, and the one or more maps 630 may process sensor data, as described above, and may send their respective outputs, over the one or more network(s) 634, to the computing device(s) 636. In at least one example, the localization component 620, the perception component 622, the prediction component 626, the planner component 628, the one or more system controllers 632, and the one or more maps 630 may send their respective outputs to the computing device(s) 636 at a particular frequency, after a lapse of a predetermined period of time, in near real-time, etc.

In some examples, the vehicle 602 may send sensor data to the computing device(s) 636 via the network(s) 634. In some examples, the vehicle 602 may receive sensor data from the computing device(s) 636 and/or remote sensor system(s) via the network(s) 634. The sensor data may include raw sensor data and/or processed sensor data and/or representations of sensor data. In some examples, the sensor data (raw or processed) may be sent and/or received as one or more log files.

The computing device(s) 636 may include processor(s) 638 and a memory 640, which may include a local graph component 624, a trajectory generating component 642, a trajectory cost component 644, and/or a trajectory determining component 646. In some examples, the memory 640 may store one or more of components that are similar to the component(s) stored in the memory 618 of the vehicle 602. In such examples, the computing device(s) 636 may be configured to perform one or more of the processes described herein with respect to the vehicle 602. In some examples, the local graph component 624, the trajectory generating component 642, the trajectory cost component 644, and/or the trajectory determining component 646 may perform substantially similar functions as the planning component 628.

The processor(s) 616 of the vehicle 602 and the processor(s) 638 of the computing device(s) 636 may be any suitable processor capable of executing instructions to process data and perform operations as described herein. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 618 and memory 640 are examples of non-transitory computer-readable media. The memory 618 and memory 640 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 6 is illustrated as a distributed system, in alternative examples, components of the vehicle 602 may be associated with the computing device(s) 636 and/or components of the computing device(s) 636 may be associated with the vehicle 602. That is, the vehicle 602 may perform one or more of the functions associated with the computing device(s) 636, and vice versa.

The methods described herein represent sequences of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes. In some examples, one or more operations of the method may be omitted entirely. For instance, the operations may include determining a first action and a second action by the vehicle relative to a selected trajectory without determining a respective cost for one or more of the actions by the vehicle. Moreover, the methods described herein may be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

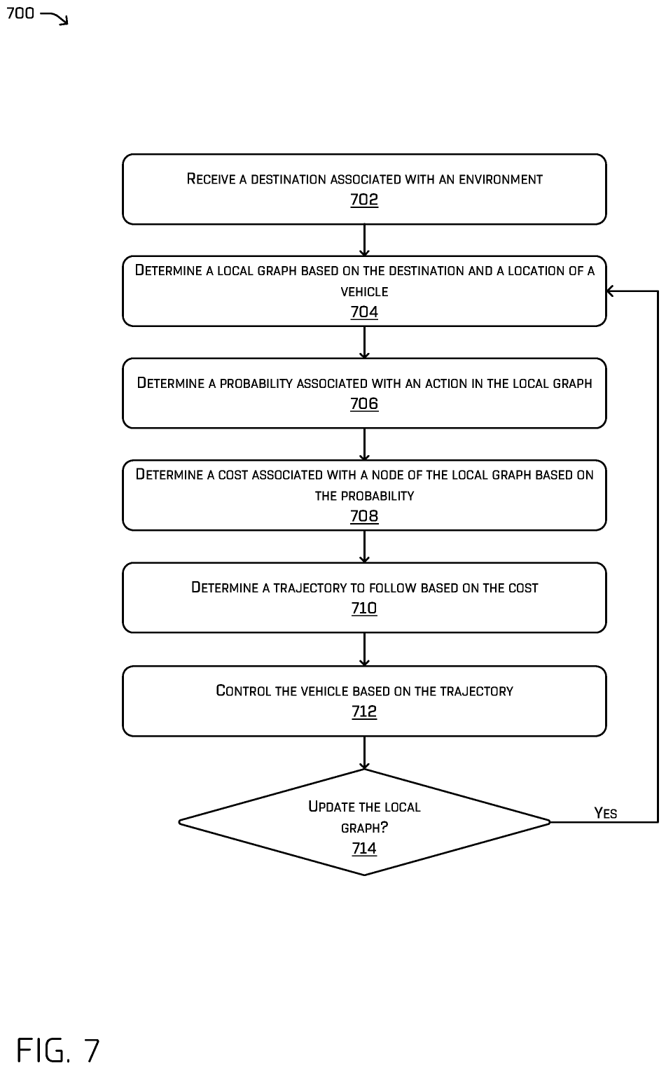

FIG. 7 is a flow diagram illustrating an example process 700 for receiving a destination, generating a local graph based on the destination, determining cost(s) associated with the local graph, determining a cost associated with a trajectory based on the local graph, and controlling a vehicle based on the trajectory. As described below, the example process 700 may be performed by one or more computer-based components configured to implement various functionalities described herein. For instances, process 700 may be performed using a planning component 202.

Process 700 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 702, the planning component may receive a destination associated with an environment. A vehicle may receive instruction(s) (e.g., transport passenger(s), deliver item(s), etc.) to navigate from a starting location to an ending location (or destination). Such instruction(s) may be received from a fleet management system, a remote operating system, a passenger or a passenger device, a future passenger, and/or any other source. In some examples, a destination may be a location within the environment to which the vehicle is to navigate. That is, the instructions may include a location (e.g., x-y coordinate) within the environment associated with a destination.

At operation 704, the planning component may determine a local graph based on the destination and a location of the vehicle. A local graph may be a graph or map that represents the driving lane(s) and/or driving segment(s) (e.g., a portion of a driving lane) of the physical environment spanning or otherwise covering a smaller portion of the physical environment than that of the entire distance to the destination, while also extending beyond the distance covered by candidate trajectories. That is, the local graph may cover a larger distance from the vehicle than the distance covered by the candidate trajectories. The region of the physical environment covered by the local graph may define a local search horizon corresponding to the local graph. The local search horizon may be the region within which the planning component may determine costs of state(s) (or nodes) and/or edges based on incorporating data from the current driving scenario (e.g., detected object(s), traffic flow, etc.).

The planning component may generate a lane graph (or representation) spanning the region within the local search horizon. The lane graph may be generated based on map data, such as road network data, lane segment data, and/or any other type of data. In such instances, the planning component may generate or otherwise determine a lane graph based on the lane segment data (e.g., lane segment dimension, location, shape, type, etc.) and/or the combinations of lane segment(s) (or road segments) in the environment.

In some examples, the planning component may generate the local graph based on the lane graph. As indicated above, the local graph may extend from the location of the vehicle to the end of the local search horizon or to the destination (if the destination is located within the local search horizon) and contain a plurality of states, a plurality of edges, a plurality of actions, and/or a plurality of probabilities associated with the actions. In some instances, the planning component may generate the local graph based on modifying the lane graph (e.g., by adding features (e.g., node(s), edge(s), action(s), probabilities, cost(s)), etc. to the lane graph); however, in other examples, the planning component may generate a separate local graph based on or referencing the lane graph. In some examples, the planning component may generate a single local graph during the vehicle startup phase, and that local graph may be used to generate local graphs while the vehicle navigates from the starting location to the destination location.

At operation 706, the planning component may determine a probability associated with a transition of an action in the local graph. A probability may represent a probability of transitioning to an intended state of the action based on the vehicle following the flow of traffic. For example, the local graph may include a lane change action connecting a first state in a first lane with a second state in a second lane. In this example, the planning component may determine a probability that the vehicle will be able to change lanes and arrive at the second state. The planning component may determine the probability value by using Equation 1 and/or Equation 2.

At operation 708, the planning component may determine a cost associated with a node (or state) of the local graph based on the probability. That is, based on determining the probabilities associated with the transitions of the actions, the planning component may determine cost values associated with some or all states within the local graph. In some examples, the planning component may associate a cost-to-go (e.g., a terminal cost) with each state within the local graph. As described above, the cost-to-go may represent a cost for the vehicle to go from a state to the boundary of the local search horizon or to the destination. In some examples, the planning component may determine cost-to-go values for some or all states within the local graph. As such, the planning component may initially determine cost-to-go values for the terminal states (e.g., ending states in the local graph, states that lack edges leaving the state, etc.) of the local graph. In such cases, the planning component may then proceed to determine cost-to-go values for each of the preceding states in the local graph using the cost-to-go values of the terminal state(s).

In some examples, the planning component may determine a cost-to-go for a non-terminal state by solving for the optimal policy. A policy may be an action taken from a particular state. That is, as described above, a state may have one or more actions the vehicle may perform such as stay in lane, change lane, etc. In this example, the optimal policy may be the action resulting in the lowest cost-to-go between the one or more actions. Accordingly, based on identifying the optimal policy for each state within the local graph, the planning component may associate the cost-to-go values of the optimal policy to the state. Specifically, the planning component may determine the optimal policy using Equation 3 and/or Equation 4.

At operation 710, the planning component may determine a trajectory to follow based on the cost. The planning component may generate, select, and/or follow multiple candidate trajectories through the environment to the destination. In some instances, the candidate trajectories may include instructions that instruct the vehicle how to navigate a portion of the environment. That is, the candidate trajectories may extend, from the current location of the vehicle, a predetermined distance and/or period of time. For instance, the candidate trajectories may extend eight seconds into the future, or may extend 100 meters from the location of the vehicle. However, this is not intended to be limiting; in other examples, the candidate trajectories may be based on a different period of time and/or distance.

Based on generating the candidate trajectories, the planning component determine an overall cost for following the trajectory based on determining and/or combining a cost of traversing the trajectory (e.g., cost based on factors from within the trajectory horizon) and a cost-to-go to the destination (e.g., cost obtained from the local graph-cost based on factors beyond the trajectory horizon). The combination of the costs may be considered an overall cost and may be used to determine which of the multiple candidate trajectories to follow. Initially, the planning component may generate a tree structure that includes some or all of the candidate trajectories. A tree structure may include one or more nodes representing vehicle states at different action layers of the tree structure. Further, each vehicle state may include multiple candidate trajectories which the vehicle may follow. As described in more detail below, the planning component may use the tree structure to determine or otherwise select one or more of the candidate trajectories to follow within the environment. Example techniques for generating a tree structure and determining a control trajectory based on the tree structure can be found, for example, in U.S. application Ser. No. 17/900,658, filed Aug. 21, 2022, and titled “Trajectory Prediction Based on a Decision Tree,” the contents of which is herein incorporated by reference in its entirety and for all purposes.

In some examples, the planning component may determine a cost-to-go to the destination for a candidate trajectory. The planning component may identify an end (or final) state of the candidate trajectory and project the end state onto the local graph. In some examples, the planning component may connect the end state of the candidate trajectory to the states of the local graph by generating (or otherwise associating) one or more new actions (e.g., action(s) not previously included in the local graph) between the end state of the candidate trajectory and the states of the local graph. Based on associating new action(s) to the local graph, the planning component may create edges from the end state to the action and additional edges from the action to any of the states within the local graph. In this example, the planning component may determine probabilities associated with such action(s). Upon determining the probabilities, the planning component may determine a cost-to-go value corresponding to the end state of the candidate trajectory based on the probabilities, the cost-to-go values of the connecting states, etc. Specifically, the planning component may determine the cost-to-go for the end state by using Equation 3 and/or Equation 4. Based on having determined the cost-to-go for the end state of the candidate trajectory, the planning component may combine (e.g., add costs together, weighted sum, etc.) the cost to transition to the end of the trajectory horizon with the cost-to-go to the destination. The combination of the two costs may be considered the overall cost. In some examples, the planning component may determine to follow a trajectory that has the lowest overall cost compared to the overall costs of other potential candidate trajectories.

At operation 712, the planning component may control the vehicle based on the trajectory. Upon determining the control trajectory from the tree search, the vehicle may follow the control trajectory throughout the environment.

At operation 714, the planning component may determine whether to update the local graph. In some examples, the planning component may update the local graph while the vehicle traverses the environment according to an operating tick of the planner component. An operating tick may be a frequency (e.g., 1 millisecond, 5 milliseconds, etc.) and/or duration of a processing cycle within the planning component. As such, in some examples, the planning component may update the local graph at each operating tick. However, in other examples, the local graph may be updated at any other suitable frequency (e.g., every N number of ticks, where N is an integer greater than zero, based on movement of the vehicle, velocity of the vehicle, number of additional objects proximate the vehicle, difficulty of maneuvers, proximity to the endpoint, etc.). As such, an updated local graph may span a different region of the environment than a previous version of the local graph based on the movement of the vehicle. Accordingly, if the planning component determines that the local graph needs to be updated (714:Yes), the planning component may update the local graph. That is, the planning component may return to operation 704 and continue such operations until the vehicle has arrived at the destination.

### Example Clauses

A: A system comprising: one or more processors; and one or more non-transitory computer-readable media storing computer-executable instructions that, when executed, cause the system to perform operations comprising: receiving a destination associated with an environment; receiving, from a sensor associated with a vehicle, sensor data associated with the environment; determining, based at least in part on the destination and the sensor data, a plurality of lane segments associated with a region of the environment between a position of a vehicle and the destination; determining, based at least in part on the plurality of lane segments and the sensor data, a graph comprising a plurality of nodes and a plurality of edges between the plurality of nodes, the graph including an action for the vehicle to transition from a first node of the plurality of nodes to a second node of the plurality of nodes; determining, based at least in part on the sensor data, a probability of the transition associated with the action; determining, based at least in part on the probability, a cost associated with the first node, the cost representing a cost of navigating from the first node to a boundary of the graph; determining, based at least in part on the graph, a trajectory for the vehicle to follow; and controlling the vehicle based at least in part on the trajectory.

B: The system of paragraph A, wherein the action is a first action, wherein determining the trajectory for the vehicle comprises: identifying an ending state of the trajectory; associating the ending state of the trajectory with the graph; associating a second action to the graph, the second action located between the ending state and the first node; associating an edge with the ending state of the trajectory, the second action, and the first node; and determining, based at least in part on the second action and the edge, a second cost associated with the ending state of the trajectory.

C: The system of paragraph A, wherein the cost is a first cost and the action is a first action, and wherein determining the first cost comprises: identifying a second action within the graph; determining, based at least in part on the first action, a second cost; determining, based at least in part on the second action, a third cost; and determining, based at least in part on the second cost being less than the third cost, that the second cost is the first cost.

D: The system of paragraph A, wherein determining the cost is based at least in part on a transition cost associated with navigating from the first node to the second node, determining the transition cost is based at least in part on at least one of: a distance between the first node and the second node, a time to navigate from the first node to the second node a number of lane changes associated with navigating from the first node to the second node, or an object located at least partially between the first node and the second node.

E: The system of paragraph A, wherein determining the probability of the transition is based at least in part on at least one of: a distance between the first node and the second node, a time to navigate from the first node to the second node, a number of lane changes associated with navigating from the first node to the second node, or an object located at least partially between the first node and the second node.

F: One or more non-transitory computer-readable media storing instructions executable by one or more processors, wherein the instructions, when executed, cause a system to perform operations comprising: receiving a destination associated with an environment; determining, based at least in part on the destination, a graph comprising a plurality of nodes and a plurality of edges between the plurality of nodes; determining a probability associated with an action for a vehicle to perform to move between two nodes of the plurality of nodes; determining, based at least in part on the probability, a cost associated with a node of the plurality of nodes representing a cost of navigating from the node to a boundary of the graph; and determining, based at least in part on the graph and the cost, a trajectory for the vehicle to follow.

G: The one or more non-transitory computer-readable media of paragraph F, wherein the action is a first action, wherein determining the trajectory for the vehicle comprises: identifying an ending state of the trajectory; associating a second action to the graph, the second action being located between the ending state and the node; and determining, based at least in part on the second action, a second cost associated with the ending state of the trajectory.

H: The one or more non-transitory computer-readable media of paragraph F, wherein the cost is a first cost and the action is a first action, and wherein determining the first cost comprises: identifying a second action associated with the graph; determining, based at least in part on the first action, a second cost; determining, based at least in part on the second action, a third cost; and determining, based at least in part on the second cost being less than the third cost, that the second cost is the first cost.

I: The one or more non-transitory computer-readable media of paragraph F, wherein the node is a first node, wherein the first node is connected to a second node by the action, and wherein determining the probability is based at least in part on at least one of: a distance between the first node and the second node, a time to navigate from the first node to the second node, a number of lane changes associated with navigating from the first node to the second node, or an object located at least partially between the first node and the second node.

J: The one or more non-transitory computer-readable media of paragraph F, wherein determining the cost is based at least in part on a transition cost associated with navigating from a first node of the plurality of nodes to a second node of the plurality of nodes, determining the transition cost is based at least in part on at least one of: a distance between the first node and the second node, a time to navigate from the first node to the second node a number of lane changes associated with navigating from the first node to the second node, or an object located at least partially between the first node and the second node.

K: The one or more non-transitory computer-readable media of paragraph J, wherein determining the graph is based at least in part on at least one of: determining, based at least in part on sensor data associated with the environment, a transition cost representing a value of transitioning from between the two nodes, detecting, based at least in part on the sensor data, an object blocking a driving lane associated with a portion of the graph, or associating, based at least in part on the sensor data, an additional action with the graph, the additional action instructing the vehicle to return to a previous state or to reduce velocity.

L: The one or more non-transitory computer-readable media of paragraph F, the operations further comprising: controlling the vehicle based at least in part on the trajectory.

M: The one or more non-transitory computer-readable media of paragraph F, wherein the boundary includes the destination.

N: A method comprising: receiving a destination associated with an environment; determining, based at least in part on the destination, a graph comprising a plurality of nodes and a plurality of edges between the plurality of nodes; determining a probability associated with an action for a vehicle to perform to move between two nodes of the plurality of nodes; determining, based at least in part on the probability, a cost associated with a node of the plurality of nodes representing a cost of navigating from the node to a boundary of the graph; and determining, based at least in part on the graph and the cost, a trajectory for the vehicle to follow.

O: The method of paragraph N, wherein the action is a first action, wherein determining the trajectory for the vehicle comprises: identifying an ending state of the trajectory; associating a second action to the graph, the second action being located between the ending state and the node; and determining, based at least in part on the second action, a second cost associated with the ending state of the trajectory.

P: The method of paragraph N, wherein the cost is a first cost and the action is a first action, and wherein determining the first cost comprises: identifying a second action associated with the graph; determining, based at least in part on the first action, a second cost; determining, based at least in part on the second action, a third cost; and determining, based at least in part on the second cost being less than the third cost, that the second cost is the first cost.

Q: The method of paragraph N, wherein the node is a first node, wherein the first node is connected to a second node by the action, and wherein determining the probability is based at least in part on at least one of: a distance between the first node and the second node, a time to navigate from the first node to the second node, a number of lane changes associated with navigating from the first node to the second node, or an object located at least partially between the first node and the second node.

R: The method of paragraph N, wherein determining the cost is based at least in part on a transition cost associated with navigating from a first node of the plurality of nodes to a second node of the plurality of nodes, determining the transition cost is based at least in part on at least one of: a distance between the first node and the second node, a time to navigate from the first node to the second node a number of lane changes associated with navigating from the first node to the second node, or an object located at least partially between the first node and the second node.

S: The method of paragraph R, wherein determining the graph is based at least in part on at least one of: determining, based at least in part on sensor data associated with the environment, a transition cost representing a value of transitioning from between the two nodes, detecting, based at least in part on the sensor data, an object blocking a driving lane associated with a portion of the graph, or associating, based at least in part on the sensor data, an additional action with the graph, the additional action instructing the vehicle to return to a previous state or to reduce velocity.

T: The method of paragraph N, further comprising: controlling the vehicle based at least in part on the trajectory.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the system to perform operations comprising:
receiving a destination associated with an environment;
receiving, from a sensor associated with a vehicle, sensor data associated with the environment;
determining, based at least in part on the destination and the sensor data, a plurality of lane segments associated with a region of the environment between a position of a vehicle and the destination;
determining, based at least in part on the plurality of lane segments and the sensor data, a graph comprising a plurality of nodes and a plurality of edges between the plurality of nodes, the graph including an action for the vehicle to transition from a first node of the plurality of nodes to a second node of the plurality of nodes;
determining, based at least in part on the sensor data, a probability of the transition associated with the action;
determining, based at least in part on the probability, a cost associated with the first node, the cost representing a cost of navigating from the first node to a boundary of the graph;
determining, based at least in part on the graph, a trajectory for the vehicle to follow; and
controlling the vehicle based at least in part on the trajectory.

2. The system of claim 1, wherein the action is a first action, wherein determining the trajectory for the vehicle comprises:
identifying an ending state of the trajectory;
associating the ending state of the trajectory with the graph;
associating a second action to the graph, the second action located between the ending state and the first node;
associating an edge with the ending state of the trajectory, the second action, and the first node; and
determining, based at least in part on the second action and the edge, a second cost associated with the ending state of the trajectory.

3. The system of claim 1, wherein the cost is a first cost and the action is a first action, and wherein determining the first cost comprises:
identifying a second action within the graph;
determining, based at least in part on the first action, a second cost;
determining, based at least in part on the second action, a third cost; and
determining, based at least in part on the second cost being less than the third cost, that the second cost is the first cost.

4. The system of claim 1, wherein determining the cost is based at least in part on a transition cost associated with navigating from the first node to the second node, determining the transition cost is based at least in part on at least one of:
a distance between the first node and the second node,
a time to navigate from the first node to the second node
a number of lane changes associated with navigating from the first node to the second node, or
an object located at least partially between the first node and the second node.

5. The system of claim 1, wherein determining the probability of the transition is based at least in part on at least one of:
a distance between the first node and the second node,
a time to navigate from the first node to the second node,
a number of lane changes associated with navigating from the first node to the second node, or
an object located at least partially between the first node and the second node.

6. One or more non-transitory computer-readable media storing instructions executable by one or more processors, wherein the instructions, when executed, cause a system to perform operations comprising:
receiving a destination associated with an environment;
determining, based at least in part on the destination, a graph comprising a plurality of nodes and a plurality of edges between the plurality of nodes;
determining a probability associated with an action for a vehicle to perform to move between two nodes of the plurality of nodes;
determining, based at least in part on the probability, a cost associated with a node of the plurality of nodes representing a cost of navigating from the node to a boundary of the graph; and
determining, based at least in part on the graph and the cost, a trajectory for the vehicle to follow.

7. The one or more non-transitory computer-readable media of claim 6, wherein the action is a first action, wherein determining the trajectory for the vehicle comprises:
identifying an ending state of the trajectory;
associating a second action to the graph, the second action being located between the ending state and the node; and
determining, based at least in part on the second action, a second cost associated with the ending state of the trajectory.

8. The one or more non-transitory computer-readable media of claim 6, wherein the cost is a first cost and the action is a first action, and wherein determining the first cost comprises:
identifying a second action associated with the graph;
determining, based at least in part on the first action, a second cost;
determining, based at least in part on the second action, a third cost; and
determining, based at least in part on the second cost being less than the third cost, that the second cost is the first cost.

9. The one or more non-transitory computer-readable media of claim 6, wherein the node is a first node, wherein the first node is connected to a second node by the action, and wherein determining the probability is based at least in part on at least one of:
a distance between the first node and the second node,
a time to navigate from the first node to the second node,
a number of lane changes associated with navigating from the first node to the second node, or
an object located at least partially between the first node and the second node.

10. The one or more non-transitory computer-readable media of claim 6, wherein determining the cost is based at least in part on a transition cost associated with navigating from a first node of the plurality of nodes to a second node of the plurality of nodes, determining the transition cost is based at least in part on at least one of:
a distance between the first node and the second node,
a time to navigate from the first node to the second node
a number of lane changes associated with navigating from the first node to the second node, or
an object located at least partially between the first node and the second node.

11. The one or more non-transitory computer-readable media of claim 10, wherein determining the graph is based at least in part on at least one of:
determining, based at least in part on sensor data associated with the environment, a transition cost representing a value of transitioning from between the two nodes,
detecting, based at least in part on the sensor data, an object blocking a driving lane associated with a portion of the graph, or
associating, based at least in part on the sensor data, an additional action with the graph, the additional action instructing the vehicle to return to a previous state or to reduce velocity.

12. The one or more non-transitory computer-readable media of claim 6, the operations further comprising:
controlling the vehicle based at least in part on the trajectory.

13. The one or more non-transitory computer-readable media of claim 6, wherein the boundary includes the destination.

14. A method comprising:
receiving a destination associated with an environment;
determining, based at least in part on the destination, a graph comprising a plurality of nodes and a plurality of edges between the plurality of nodes;
determining a probability associated with an action for a vehicle to perform to move between two nodes of the plurality of nodes;
determining, based at least in part on the probability, a cost associated with a node of the plurality of nodes representing a cost of navigating from the node to a boundary of the graph; and
determining, based at least in part on the graph and the cost, a trajectory for the vehicle to follow.

15. The method of claim 14, wherein the action is a first action, wherein determining the trajectory for the vehicle comprises:
identifying an ending state of the trajectory;
associating a second action to the graph, the second action being located between the ending state and the node; and
determining, based at least in part on the second action, a second cost associated with the ending state of the trajectory.

16. The method of claim 14, wherein the cost is a first cost and the action is a first action, and wherein determining the first cost comprises:
identifying a second action associated with the graph;
determining, based at least in part on the first action, a second cost;
determining, based at least in part on the second action, a third cost; and
determining, based at least in part on the second cost being less than the third cost, that the second cost is the first cost.

17. The method of claim 14, wherein the node is a first node, wherein the first node is connected to a second node by the action, and wherein determining the probability is based at least in part on at least one of:
a distance between the first node and the second node,
a time to navigate from the first node to the second node,
a number of lane changes associated with navigating from the first node to the second node, or
an object located at least partially between the first node and the second node.

18. The method of claim 14, wherein determining the cost is based at least in part on a transition cost associated with navigating from a first node of the plurality of nodes to a second node of the plurality of nodes, determining the transition cost is based at least in part on at least one of:
a distance between the first node and the second node,
a time to navigate from the first node to the second node
a number of lane changes associated with navigating from the first node to the second node, or
an object located at least partially between the first node and the second node.

19. The method of claim 18, wherein determining the graph is based at least in part on at least one of:
determining, based at least in part on sensor data associated with the environment, a transition cost representing a value of transitioning from between the two nodes,
detecting, based at least in part on the sensor data, an object blocking a driving lane associated with a portion of the graph, or
associating, based at least in part on the sensor data, an additional action with the graph, the additional action instructing the vehicle to return to a previous state or to reduce velocity.

20. The method of claim 14, further comprising:
controlling the vehicle based at least in part on the trajectory.
